(19) United States
(12) Patent Application Publication
(10) Pub. No.: US 2014/0379983 A1
(43) Pub. Date: Dec. 25, 2014

(54) STORAGE SYSTEM, CONTROL APPARATUS, AND CONTROL METHOD

(71) Applicant: FUJITSU LIMITED, Kawasaki-shi (JP)

(72) Inventor: Kazuki Sasaki, Kawasaki (JP)

(73) Assignee: FUJITSU LIMITED, Kawasaki-shi (JP)

(21) Appl. No.: 14/293,394

(22) Filed: Jun. 2, 2014

(30) Foreign Application Priority Data
Jun. 20, 2013 (JP) 2013-129393

(51) Int. Cl. G06F 3/06

(52) U.S. Cl. CPC G06F 3/0686; G06F 3/0619; G06F 3/0665
USPC 711/114

(57) ABSTRACT

A storage system includes: a library-apparatus that is configured to store a plurality of portable-recording-media and to write and read data by using the stored portable-recording-media; a storage-apparatus; and a control-apparatus configured to control access to a plurality of logical-volumes by using the storage-apparatus as a first-storage and using a storage-area provided by the plurality of portable-recording-media as a second-storage, wherein, upon receiving a request for copying a first-logical-volume of the plurality of logical-volumes, the control-apparatus copies the first-logical-volume to an unused first-recording-medium included in the plurality of portable-recording media and having the same identification-number as an identification-number of the first-logical-volume, when copying to the first-recording-medium is possible, and selects an unused second-recording-medium from the plurality of portable-recording-media, generates a second-logical-volume in which the identification-number of the first-logical-volume is changed to the same identification-number as an identification-number of the second-recording-medium, and copies the generated second-logical-volume to the second-recording-medium, when copying to the first-recording-medium is not possible.

### CROSS-REFERENCE TO RELATED APPLICATION

This application is based upon and claims the benefit of priority of the prior Japanese Patent Application No. 2013-129393, filed on Jun. 20, 2013, the entire contents of which are incorporated herein by reference.

### FIELD

The embodiments discussed herein are related to a storage system, a control apparatus, and a control method.

### BACKGROUND

Magnetic tapes, optical disks, magneto-optical disks, and so on are available as portable recording media. In particular, the magnetic tapes are utilized as recording media that realize large-capacity storage areas at back-ends in storage systems. Storage systems in which magnetic tapes are utilized for storage areas at back-ends are called “virtual tape systems”, for example.

In the virtual tape systems, there is a technology that performs, as one type of backup processing, processing in which data of a logical volume recorded on a magnetic tape stored in a library apparatus is recorded to a magnetic tape for external ejection, thereby allowing the data to be stored externally to the system. Processing for writing data to a magnetic tape for external ejection is called “export processing”, for example.

As an example of technologies regarding virtual tape systems, there is a technology in which data to be stored in an actual tape device or a virtual tape storage device is further stored in a storage device included in another computer in a system.

Also, as an example of technologies regarding reallocation of data in a storage system, there is a technology in which, when moving data from a movement-source storage area to a movement-destination storage fails, one or both of the movement-source storage area and the movement-destination storage area is/are changed to another storage area or other storage areas to create a re-execution plan, based on a plan of execution of the data movement.

Examples of the related art are disclosed in Japanese Laid-open Patent Publication No. 2010-33407 and Japanese Laid-open Patent Publication No. 2010-266993.

In the export processing in the virtual tape systems, an arbitrary magnetic tape of magnetic tapes prepared for export can be selected as an export-destination magnetic tape. It is also possible to write a plurality of logical volumes to a single magnetic tape for export. Thus, the identification number of an export-destination magnetic tape and the identification number of a logical volume to be stored on the magnetic tape may or may not match each other.

As one type of export processing, there is also processing for ejecting a magnetic tape that is usable by a library apparatus directly accessed from a host. This processing is called, for example, “native export processing” or the like. When the host directly accesses the library apparatus without involvement of the virtual tape apparatus, the host recognizes magnetic tapes in the library apparatus as physical volumes, rather than recognizing storage areas realized by magnetic tapes in the library apparatus as virtual logical volumes.

In this case, the identification number of a physical volume recognized by the host matches the identification information of a magnetic tape on which the physical volume is stored.

Thus, in the native export processing, it is important that the identification number of an export-destination magnetic tape and the identification number of a logical volume to be stored on the magnetic tape are made to match each other. However, when a fault occurs in a magnetic tape having the same identification number as that of a logical volume or when a magnetic tape having the same identification number has already been used as a back-end, there is a problem that it is difficult to execute the native export processing.

### SUMMARY

According to an aspect of the invention, A storage system includes: a library-apparatus that is configured to store a plurality of portable-recording-media and to write and read data by using the stored portable-recording-media; a storage-apparatus; and a control-apparatus configured to control access to a plurality of logical-volumes by using the storage-apparatus as a first-storage and using a storage-area provided by the plurality of portable-recording-media as a second-storage, wherein, upon receiving a request for copying a first-logical-volume of the plurality of logical-volumes, the control-apparatus copies the first-logical-volume to an unused first-recording-medium included in the plurality of portable-recording media and having the same identification-number as an identification-number of the first-logical-volume, when copying to the first-recording-medium is possible, and selects an unused second-recording-medium from the plurality of portable-recording-media, generates a second-logical-volume in which the identification-number of the first-logical-volume is changed to the same identification-number as an identification-number of the second-recording-medium, and copies the generated second-logical-volume to the second-recording-medium, when copying to the first-recording-medium is not possible.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example configuration and example processing of a storage system according to a first embodiment;

FIG. 2 is a block diagram illustrating an example of the system configuration of a storage system according to a second embodiment;

FIG. 3 is a block diagram illustrating an example of the hardware configuration of a control apparatuses;

FIG. 4 is a block diagram illustrating an example of the hardware configuration of a tape library apparatus;

FIG. 5 is a diagram illustrating an overview of host I/O processing;

FIG. 6 is a diagram illustrating an overview of ordinary export;

FIG. 7 illustrates an example of a data format used in the ordinary export;

FIG. 8 is a diagram illustrating an example of a library system;

FIG. 9 is a diagram illustrating an overview of native export;

FIG. 10 illustrates an example of a data format in the native export;

FIG. 11 is a block diagram illustrating an example of processing functions of the control apparatus;

FIG. 12 illustrates an example of information registered in an LV management table;

FIG. 13 illustrates an example of information registered in a tape management table;

FIG. 14 illustrates an example of information registered in an export history table;

FIG. 15 is a first flowchart illustrating example processing performed by the control apparatus during execution of the native export;

FIG. 16 is a second flowchart illustrating example processing performed by the control apparatus during execution of the native export;

FIG. 17 is a flowchart illustrating an example of processing for determining whether or not the number of available export tapes is sufficient;

FIGS. 18A and 18B illustrate the processes in steps S25 to S27 and processes subsequent thereto;

FIG. 19 is a third flowchart illustrating example processing performed by the control apparatus during execution of the native export;

FIG. 20 is a fourth flowchart illustrating example processing performed by the control apparatus during execution of the native export; and

FIG. 21 is a table illustrating an example of acquired information.

### DESCRIPTION OF EMBODIMENTS

Embodiments of the present disclosure will be described below with reference to the accompanying drawings.

### First Embodiment

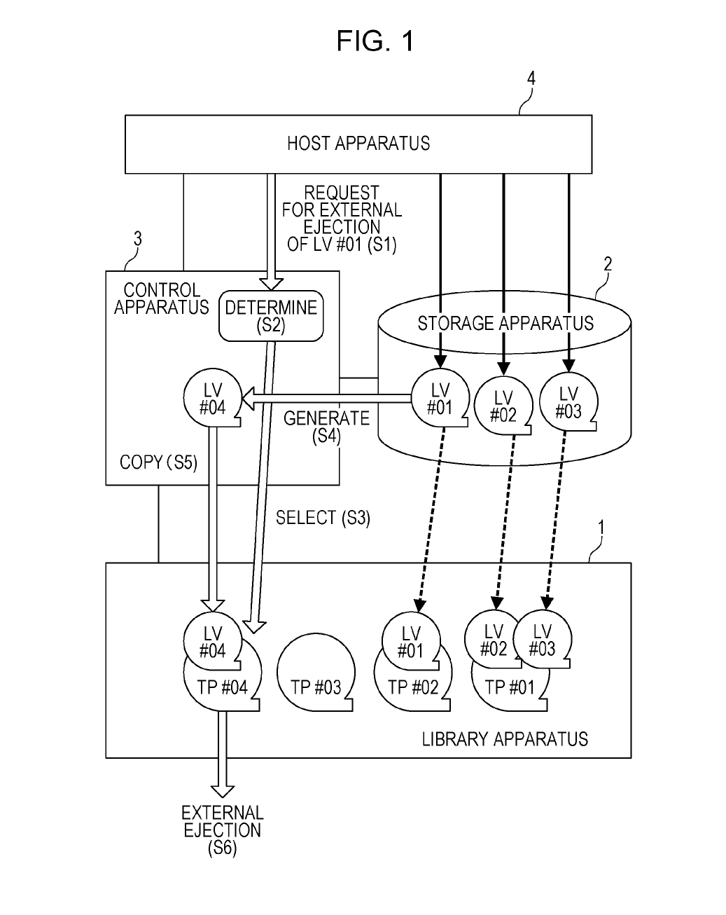

FIG. 1 is a diagram illustrating an example configuration and example processing of a storage system according to a first embodiment.

The storage system illustrated in FIG. 1 includes a library apparatus 1, a storage apparatus 2, and a control apparatus 3. A host apparatus 4 is connected to the control apparatus 3. The host apparatus 4 is one example of an apparatus that accesses logical volumes.

The library apparatus 1 stores a plurality of portable recording media and performs writing and reading of data by using the stored portable recording media. In the present embodiment, the portable recording media are assumed to be magnetic tapes, by way of example. The portable recording media, however, may also be, for example, optical disks or magneto-optical disks.

The magnetic tapes are given respective identification numbers. The magnetic tape with an identification number of “01” is hereinafter referred to as “TP #01”. In the example in FIG. 1, TP #01, TP #02, TP #03, and TP #04 are stored in the library apparatus 1.

The storage apparatus 2 stores therein information by using a recording medium (such as a hard disk drive (HDD) or a solid-state drive (SSD)) having a higher access speed than the portable recording media in the library apparatus 1.

The control apparatus 3 is connected to the library apparatus 1 and the storage apparatus 2. The control apparatus 3 uses the storage apparatus 2 as a primary storage, uses storage areas realized by the magnetic tapes stored in the library apparatus 1 as a secondary storage, and controls access from the host apparatus 4 to the logical volumes.

The logical volumes are given respective identification numbers. The logical volume with an identification number of “01” is referred to as “LV #01”. In the example in FIG. 1, it is assumed that LV #01, LV #02, and LV #03 have been created as logical volumes to be accessed from the host apparatus 4.

Solid-line arrows and dotted-line arrows in FIG. 1 represent examples of processing flows from the host apparatus 4 to the logical volumes during access control. Specifically, the solid-line arrows represent access from the host apparatus 4 to the logical volumes in the primary storage. The term “access” as used herein refers to writing data to a logical volume or reading data from a logical volume. The dotted-line arrows also represent writing the logical volumes in the primary storage to the secondary storage.

Although the solid-line arrows from the host apparatus 4 to the storage apparatus 2 are directly connected in FIG. 1, access from the host apparatus 4 to the storage apparatus 2 is in practice controlled by the control apparatus 3. Similarly, although the dotted-line arrows are directly connected from the storage apparatus 2 to the library apparatus 1 in FIG. 1, writing from the storage apparatus 2 to the magnetic tapes in the library apparatus 1 is in practice controlled by the control apparatus 3.

For example, upon receiving, from the host apparatus 4, a request for writing to LV #01, the control apparatus 3 performs the requested writing to LV #01 stored in the storage apparatus 2. Subsequently, at an arbitrary timing, the control apparatus 3 also writes LV #01 in the storage apparatus 2 to an arbitrary one of the magnetic tapes in the library apparatus 1.

Through processing as described above, access from the host apparatus 4 to the logical volumes is made via the storage apparatus 2. That is, the storage apparatus 2 is used as a primary storage for the logical volumes. This increases the speed of processing for access from the host apparatus 4 to the logical volumes. An arbitrary one of the magnetic tapes in the library apparatus 1 is also used as a secondary storage for the logical volumes.

During writing of a logical volume to the secondary storage, the control apparatus 3 may select, as a write destination, an arbitrary magnetic tape from magnetic tapes permitted for use as a secondary storage. The control apparatus 3 may also write a plurality of logical volumes to one magnetic tape. In the example in FIG. 1, LV #02 and LV #03 have been written to one magnetic tape, TP #01. Thus, during writing of a logical volume to the secondary storage, the identification number of a logical volume to be written and the identification number of a magnetic tape to which the logic volume is to be written may or may not match each other.

Next, a description will be given of magnetic-tape external ejection processing controlled by the control apparatus 3. The expression “external ejection processing” as used herein is one type of processing for copying a logical volume specified by the host apparatus 4 to a magnetic tape. More specifically, the external ejection processing is processing in which a magnetic tape to which data of a specified logical volume is written is created in a format that can be used unmodified by a library apparatus having a system in which it is directly accessed from a host apparatus and the magnetic tape is ejected from the library apparatus 1.

In a library apparatus employing a system in which it is directly accessed from a host apparatus, the host apparatus recognizes each of the magnetic tapes in the library apparatus as a volume to be accessed. Thus, the identification number of a magnetic tape and the identification number of a volume recorded on the magnetic tape match each other.

In the external ejection processing, a logical volume specified by the host apparatus 4 is written to the magnetic tape having the same identification number as that of the logical volume, and the magnetic tape is ejected from the library apparatus 1. Since the identification number of the magnetic tape ejected as described above and the identification number of the logical volume recorded on the magnetic tape match each other, the ejected magnetic tape can be used unmodified by a library apparatus having a system in which it is directly accessed from a host apparatus, like that described above.

Now, a description will be given of example processing when LV #01 is specified as an external-ejection target (a first logical volume).

The control apparatus 3 receives, from the host apparatus 4, a request for the external ejection of LV #01 to outside (step S1). The control apparatus 3 determines whether or not copying to an unused magnetic tape (a first recording medium) having the same identification number as LV #01 is possible (step S2). The term “unused magnetic tapes” as used herein refers to, of the magnetic tapes stored in the library apparatus 1, all magnetic tapes to which no logical volumes have been written, but may also be, as another example, magnetic tapes prepared for only the external ejection independently from magnetic tapes for the secondary storage.

When it is determined in step S2 that TP #01 is stored in the library apparatus 1 and TP #01 has not been used, the control apparatus 3 copies LV #01 to TP #01 (this copying is not illustrated). After the copying is completed, the control apparatus 3 causes TP #01 to be ejected from the library apparatus 1 to outside. Since the identification number of TP #01 ejected at this time and the identification number of the written volume match each other, TP #01 can be used unmodified by a library apparatus having a system in which it is directly accessed from a host apparatus, like that described above.

On the other hand, assume a case in which it is determined in step S2 that copying to an unused magnetic tape (TP #01) having the same identification number as LV #01 is not possible. Examples of this case include a case in which TP #01 is not stored in the library apparatus 1 and a case in which TP #01 is stored in the library apparatus 1 but is not usable because of a fault or the like in TP #01. Further examples include a case in which copying from LV #01 to TP #01 is started as described above but abnormal termination occurs in processing in the middle of the copying.

In such a case, rather than suspending the external ejection processing and notifying the host apparatus 4 of the abnormal termination, the control apparatus 3 in the present embodiment continues the external ejection processing in the manner described below.

The control apparatus 3 selects an unused magnetic tape (a second recording medium) from the magnetic tapes stored in the library apparatus 1 (step S3). In the example in FIG. 1, it is assumed that TP #04 is selected. The magnetic tape that is selected in this case may also be a magnetic tape prepared for the external ejection, independently from the magnetic tapes for the secondary storage.

After step S3, the control apparatus 3 generates LV #04 (a second logical volume) in which the identification number of LV #01, for which a request for the external ejection was issued, has been changed so as to be the same identification number as that of the selected TP #04 (step S4). The control apparatus 3 then copies the generated LV #04 to TP #04 (step S5). At a predetermined timing after the copying is completed, the control apparatus 3 causes TP #04 to be ejected from the library apparatus 1 to outside (step S6).

Since the identification number “04” of the magnetic tape ejected as described above and the identification number “04” of the logical volume recorded on the magnetic tape match each other, the ejected magnetic tape can be used unmodified by a library apparatus having a system in which it is directly accessed from a host apparatus, like that described above.

As a result of the above-described processing, even when copying to an unused magnetic tape having the same identification number as that of a specified logical volume is not possible, it is possible to continuously execute the external ejection processing. The continuation of the external ejection processing makes it possible to reliably create a magnetic tape on which substantial contents of the specified logical volume are recorded and which has an identification number that matches the volume identification number written thereto match each other. Then, the magnetic tape that can be used unmodified by a library apparatus having a system in which it is directly accessed from a host apparatus can be ejected from the library apparatus 1. This makes it possible to reduce the probability of abnormal termination of the external ejection processing and also allows a logical volume specified by the host apparatus 4 to be reliably utilized by another library apparatus.

### Second Embodiment

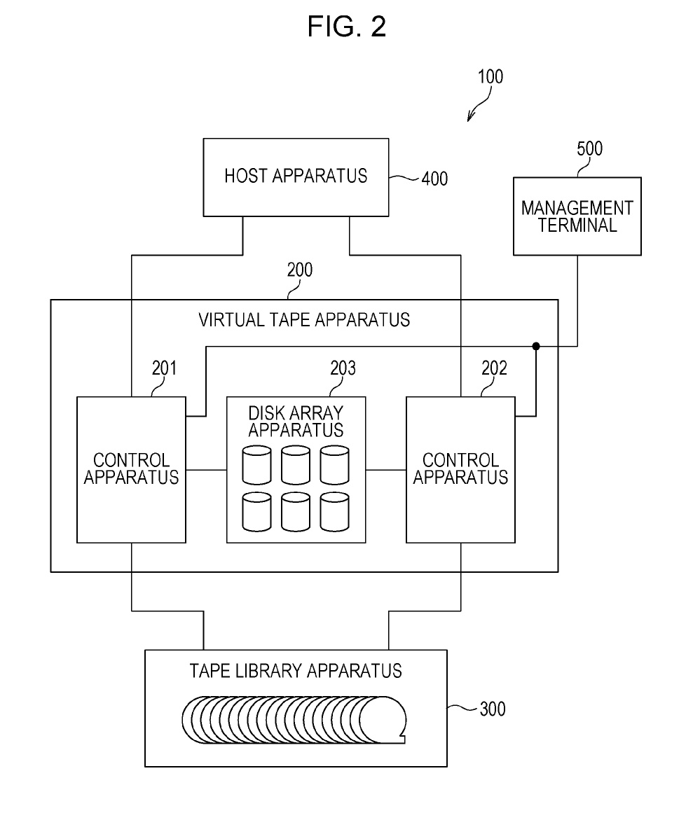

FIG. 2 is a block diagram illustrating an example of the system configuration of a storage system according to a second embodiment. A storage system 100 includes a virtual tape apparatus 200 and a tape library apparatus 300. A host apparatus 400 and a management terminal 500 are connected to the virtual tape apparatus 200.

The tape library apparatus 300 is a storage apparatus in which magnetic tapes are used as recording media. The tape library apparatus 300 has a plurality of tape drives that access data on the magnetic tapes, a mechanism for transporting a tape cartridge accommodating the magnetic tape, and so on, as described below.

The tape library apparatus 300 may also be provided, for example, in the same housing of the virtual tape apparatus 200.

The virtual tape apparatus 200 includes control apparatuses 201 and 202 and a disk array apparatus 203. The disk array apparatus 203 is a storage apparatus including a plurality of HDDs.

Although the control apparatuses 201 and 202 and the disk array apparatus 203 are assumed to be provided in the same housing in the present embodiment, they may also be provided in discrete housings.

The control apparatuses 201 and 202 control an operation for data transfer between the host apparatus 400 and the disk array apparatus 203 and an operation for data transfer between the disk array apparatus 203 and the tape library apparatus 300.

The control apparatuses 201 and 202 have a redundant configuration and perform control so that the storage system 100 operates as a hierarchical virtual tape library system in which magnetic tapes in the tape library apparatus 300 are used as a back-end library device (a secondary storage) and the HDDs in the disk array apparatus 203 are used as a cache device (a primary storage). The “virtual tape library system” as used herein refers to a system adapted to allow the host apparatus 400 to virtually use a large-capacity storage area, realized by the tape library apparatus 300, via the disk array apparatus 203.

The recording media used as the back-end in the virtual tape library system may also be, for example, portable recording media, such as optical disks and magneto-optical disks, other than magnetic tapes.

The storage device used as the cache device in the virtual tape library system may also be implemented by SSDs and so on, other than HDDs.

The control apparatuses 201 and 202 control, for example, data transfer operations for logical volumes that are different from each other. For example, when a fault occurs in one of the control apparatuses 201 and 202, the virtual tape library system is adapted so that the operation is continued with only the other control apparatus 201 or 202.

The control apparatuses 201 and 202 are further adapted to execute “export processing” for copying data, stored in a logical volume for which an eject request is issued from the host apparatus 400, to a magnetic tape for ejection and then causing the magnetic tape to be ejected from the tape library apparatus 300 to outside. The export processing is described later in detail.

In response to a user's input operation, the host apparatus 400 issues an access request to at least one of the control apparatuses 201 and 202 to thereby access the logical volume(s) in the virtual tape library system. The host apparatus 400 may also issue a notification specifying an arbitrary logical volume to the control apparatuses 201 and 202 and cause them to execute the export processing on the specified logical volume.

The management terminal 500 is a terminal apparatus operated by an administrator of the storage system 100. The administrator may recognize the states of the virtual tape apparatus 200 and the tape library apparatus 300, for example, via a display device connected to the management terminal 500. Also, when a new magnetic tape is loaded into the tape library apparatus 300, the administrator may cause the virtual tape apparatus 200 to execute processing for registering the loaded magnetic tape.

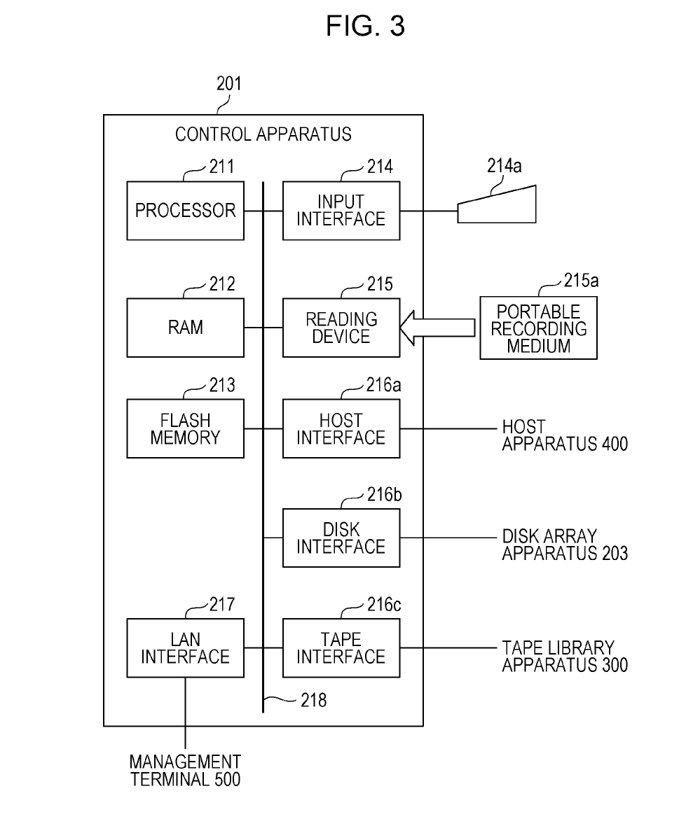

FIG. 3 is a block diagram illustrating an example of the hardware configuration of the control apparatuses. The control apparatuses 201 and 202 have the same or similar hardware configurations and are also capable of executing the same or similar processing. Thus, the configuration and the processing of the control apparatus 201 out of the control apparatuses 201 and 202 will be described below, and a description of the control apparatus 202 is not given.

The control apparatus 201 is implemented as, for example, a computer as illustrated in FIG. 3. A processor 211 controls the overall control apparatus 201. Examples of the processor 211 include a central processing unit (CPU), a micro processing unit (MPU), a digital signal processor (DSP), an application specific integrated circuit (ASIC), and a programmable logic device (PLD). The processor 211 may also be a combination of two or more of a CPU, an MPU, a DSP, an ASIC, and a PLD.

A random access memory (RAM) 212 and a plurality of pieces of peripheral equipment are coupled to the processor 211 through a bus 218.

The RAM 212 is used as a main storage device in the control apparatus 201. The RAM 212 temporarily stores therein at least part of a firmware program executed by the processor 211. The RAM 212 also stores therein various types of data used for processing performed by the processor 211.

The peripheral equipment coupled to the bus 218 includes a flash memory 213, an input interface 214, a reading device 215, a host interface 216a, a disk interface 216b, a tape interface 216c, and a local area network (LAN) interface 217.

The flash memory 213 is used as a secondary storage device in the control apparatus 201. The flash memory 213 stores therein a firmware program and various types of data. The secondary storage device may be implemented by another type of nonvolatile storage device, such as a HDD.

The input interface 214 is adapted so that, for example, an input device 214a having various operation keys and so on is connectable. The input interface 214 sends a signal, received from the input device 214a, to the processor 211 through the bus 218. The input device 214a may also be provided in/on the control apparatus 201.

A portable recording medium 215a is loaded into or removed from the reading device 215. The reading device 215 reads data recorded in/on the portable recording medium 215a and sends the read data to the processor 211. Examples of the portable recording medium 215a include an optical disk, a magneto-optical disk, and a semiconductor memory.

The host interface 216a is a communication interface that transmits/receives data to/from the host apparatus 400. The disk interface 216b is a communication interface that transmits/receives data to/from the disk array apparatus 203. The tape interface 216c is a communication interface that transmits/receives data to/from the tape library apparatus 300.

The LAN interface 217 is a communication interface that transmits/receives data to/from an external apparatus through a LAN. In the present embodiment, the LAN interface 217 transmits/receives data to/from the management terminal 500.

With a hardware configuration as described above, it is possible to realize processing functions of the control apparatus 201 (and the control apparatus 202).

Each of the host apparatus 400 and the management terminal 500 may also be realized as a computer having a processor, a RAM, and peripheral equipment, similarly to the control apparatus 201.

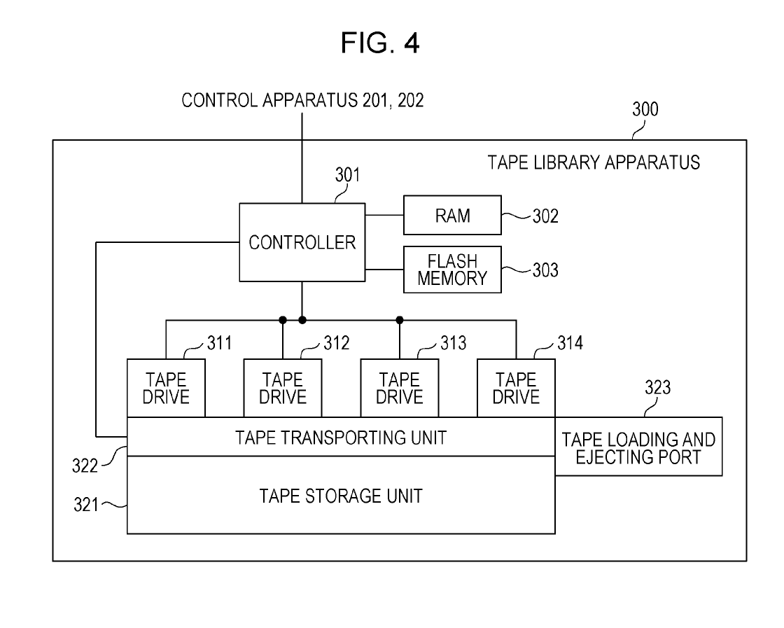

FIG. 4 is a block diagram illustrating an example of the hardware configuration of the tape library apparatus 300. The tape library apparatus 300 includes a controller 301, a RAM 302, a flash memory 303, tape drives 311 to 314, a tape storage unit 321, a tape transporting unit 322, and a tape loading and ejecting port 323.

The controller 301 includes, for example, a CPU to centrally control the overall tape library apparatus 300. The RAM 302 temporarily stores at least part of a firmware program executed by the controller 301. The RAM 302 also stores various types of data used for processing performed by the controller 301. The flash memory 303 stores therein a firmware program and various types of data.

The tape drives 311 to 314 mount, one by one, tape cartridges transported from the tape transporting unit 322, and under the control of the controller 301, the tape drives 311 to 314 write data to or read data from the respective magnetic tapes in the mounted tape cartridges. Although a description in the present embodiment is given of an example in which the tape library apparatus 300 has four tape drives, the number of tape drives is not particularly limited.

The tape storage unit 321 stores therein a plurality of tape cartridges. The tape cartridges stored in the tape storage unit 321 are broadly classified into tape cartridges for use as portions of the virtual tape library system and tape cartridges for use in the export processing. In the following description, the magnetic tapes in the former tape cartridges are referred to as “library tapes”, and the magnetic tapes in the latter tape cartridges are referred to as “export tapes”. Which of the magnetic tapes is to be used for which of the purposes is determined by the control apparatuses 201 and 202.

Under the control of the controller 301, the tape transporting unit 322 transports a tape cartridge. The tape transporting unit 322 transports, for example, any of the tape cartridges stored in the tape storage unit 321 to any of the tape drives 311 to 314 and mounts the transported tape cartridge thereon. The tape transporting unit 322 also unmounts any of the tape cartridges from the tape drives 311 to 314 and transports the unmounted tape cartridge to the tape storage unit 321 for storage therein.

A barcode label having a barcode indicating the tape name (identification number) of a magnetic tape is attached to a surface of the casing of each tape cartridge. Each tape cartridge stored in the tape storage unit 321 is given a unique tape name.

The tape transporting unit 322 has a function for reading the barcodes labels of the tape cartridges. For example, when the control apparatus 201 issues, to the tape library apparatus 300, a notification specifying the tape name of a magnetic tape to be mounted, the tape transporting unit 322 reads the barcode labels of the respective tape cartridges stored in the tape storage unit 321. The tape transporting unit 322 identifies the tape cartridge having the specified tape name, retrieves the identified tape cartridge from the tape storage unit 321, and mounts the tape cartridge on a predetermined one of the tape drive 311 to 314.

The barcode labels of the tape cartridges may also be relabeled by the administrator.

The tape transporting unit 322 has the tape loading and ejecting port 323. In response to a request from the controller 301, the tape transporting unit 322 ejects the tape cartridge, transported from any of the tape drives 311 to 314 and the tape storage unit 321, from the tape loading and ejecting port 323 to outside. The tape transporting unit 322 may also transport a tape cartridge, loaded through the tape loading and ejecting port 323, to any of the tape drives 311 to 314 and the tape storage unit 321.

Next, a description will be given of host input/output (I/O) processing and the export processing performed by the virtual tape apparatus 200.

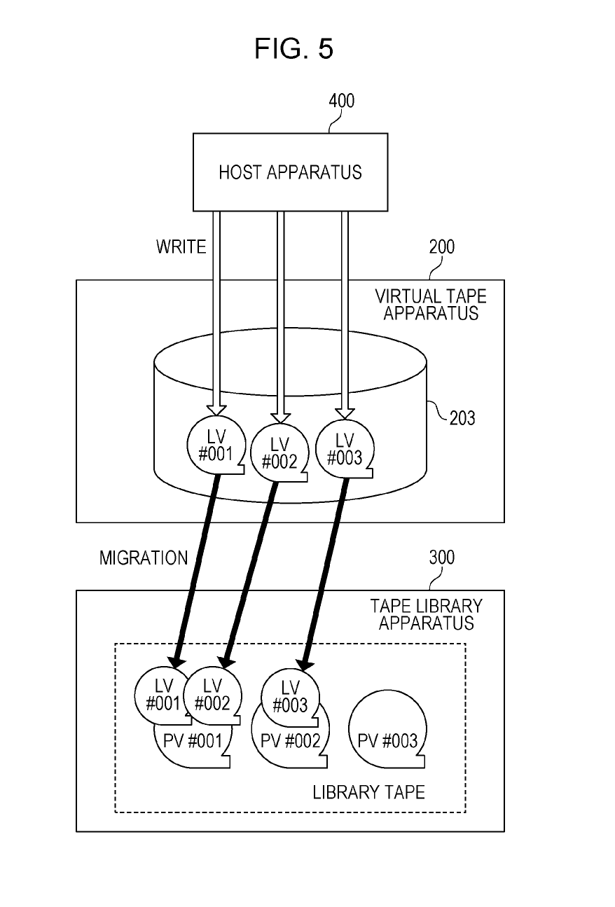

FIG. 5 is a diagram illustrating an overview of the host I/O processing. The host I/O processing is processing for accessing data stored in a virtual library system in response to a request from the host apparatus 400. FIG. 5 illustrates one example of a case in which a write request is issued from the host apparatus 400.

The virtual tape apparatus 200 generates logical volumes that emulate the respective magnetic tapes (physical volumes) and causes the host apparatus 400 to recognize the logical volumes. The host apparatus 400 recognizes the respective logical volumes as magnetic tapes to make access thereto. In practice, however, the disk array apparatus 203, which serves as a primary storage, is interposed between the host apparatus 400 and the magnetic tapes. This increases an apparent speed of access from the host apparatus 400 to the magnetic tapes. The virtual tape apparatus 200 arbitrarily determines to which magnetic tape the data of a logical volume is to be recorded, and the host apparatus 400 does not recognize the actual magnetic tape to which the data is to be recorded.

The virtual tape apparatus 200 gives unique volume names (identification numbers) to the respective generated logical volumes to manage the logical volumes. Hereinafter, the volume name of a logical volume is referred to as a “logical volume (LV) name”, and a logical volume having an LV name “001” is referred to as “LV #001”.

FIG. 5 illustrates an example of a case in which the host apparatus 400 has generated LV #001, LV #002, and LV #003 in the disk array apparatus 203. For example, when the host apparatus 400 issues a request for writing to LV #001, the virtual tape apparatus 200 writes write data, received from the host apparatus 400, to LV #001 in the disk array apparatus 203. When the host apparatus 400 issues a request for writing to LV #002 and LV #003, the virtual tape apparatus 200 similarly writes data to LV #002 and LV #003 in the disk array apparatus 203.

The virtual tape apparatus 200 stores the data of the logical volumes in the disk array apparatus 203 onto any of the magnetic tapes in the tape library apparatus 300 at a predetermined timing. As described above, library tapes for use as the back-end storage areas in the virtual library system and export tapes for use in the export processing are prepared in the tape library apparatus 300. The library tapes are used in the host I/O processing. Processing for writing a logical volume in the disk array apparatus 203 to a library tape is called “migration”.

Hereinafter, each of the magnetic tapes in the tape library apparatus 300 is identified with a physical volume (PV) name. The PV name is the identification number of a physical volume and is recorded in a header region of each magnetic tape. The value of the PV name is the same as the tape name stated on the barcode label attached to the tape cartridge. Thus, the PV name is hereinafter used to mean the same as the tape name. The magnetic tape having a PV name “001” is referred to as “PV #001”. The PV names have values that are unique to all of the respective magnetic tapes included in the tape library apparatus 300, regardless of whether they are library tapes or export tapes.

The virtual tape apparatus 200 may store a logical volume in the disk array apparatus 203 onto an arbitrary library tape. The virtual tape apparatus 200 may also store an arbitrary number of logical volumes on a single library tape. Accordingly, the LV name of a logical volume to be migrated and the PV name of a library tape on which the logical volume is to be stored may or may not match each other. In the example in FIG. 5, LV #001 and LV #002 are stored on PV #001, and LV #003 is stored on PV #002.

For example, in the virtual tape apparatus 200, when the remaining capacity of the disk array apparatus 203 is smaller than or equal to a predetermined amount, a logical volume that has not been accessed for the longest period of time after the last access from the host apparatus 400, the logical volume being included in the logical volumes in the disk array apparatus 203, is stored on a library tape, and then the logical volume is deleted from the disk array apparatus 203.

In the virtual tape apparatus 200, when a logical volume for which a write or read request is issued from the host apparatus 400 is not stored in the disk array apparatus 203, the data of the logical volume is read from a library tape and is stored in the disk array apparatus 203, and then processing corresponding to the request from the host apparatus 400 is performed.

Next, a description will be given of the export processing. There are ordinary export and native export as the export processing. The ordinary export will now be described first, and the native export is described later.

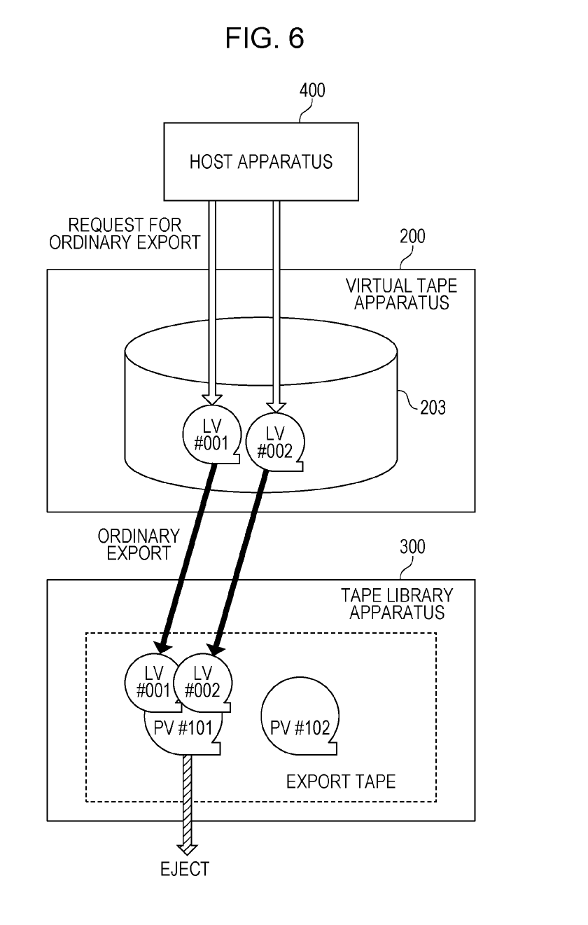

FIG. 6 is a diagram illustrating an overview of the ordinary export. The ordinary export refers to processing in which the data of a logical volume specified by the host apparatus 400 is stored on an export tape and the export tape is ejected from the tape library apparatus 300 to outside. This allows the data of the specified logical volume to be utilized in another virtual tape library system.

It is assumed that, in the example in FIG. 6, the host apparatus 400 has specified LV #001 and LV #002 as logical volumes for the ordinary export. The host apparatus 400 may also specify an arbitrary number of logical volumes as logical volumes for the ordinary export.

The virtual tape apparatus 200 selects an arbitrary magnetic tape from the export tapes prepared in the tape library apparatus 300. It is assumed that PV #101 has been selected in the example in FIG. 6. The virtual tape apparatus 200 copies the specified logical volumes, LV #001 and LV #002, from the disk array apparatus 203 to PV #101. When the specified logical volumes are not stored in the disk array apparatus 203, the virtual tape apparatus 200 reads out the logical volumes from a library tape to the disk array apparatus 203 and then copies the read logical volumes to PV #101. When the copying is completed, PV #101 is ejected from the tape library apparatus 300.

When the ejected physical volume, PV #101, is loaded into a tape library apparatus in another virtual library system, LV #001 and LV #002 stored on PV #101 can be used in the other virtual library system. The ejected physical volume, PV #101, can also be used by returning it to the original virtual tape library.

Thus, the ejected export tape can be used unmodified in a virtual library system having the same specifications. Accordingly, in the ordinary export, the LV name of a logical volume specified as a logical volume for the ordinary export and the PV name of a magnetic tape on which the logical volume is to be stored may or may not match each other, as in the case of the migration illustrated in FIG. 5.

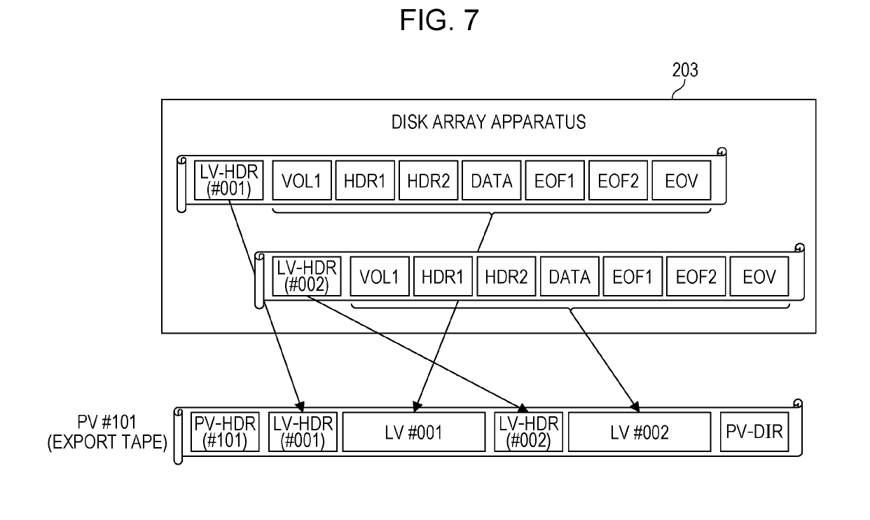

FIG. 7 illustrates an example of a data format used in the ordinary export.

First, a description will be given of an example of the data format of the logical volumes in the disk array apparatus 203. In the disk array apparatus 203, an LV header “LV-HDR” is written to a start region, and a corresponding logical volume is written to a next region. Although not illustrated, an LV name, a generation indicating the number of updates among logical volumes having the same LV name, and an LV size indicating the size of the logical volume, a creation date and time (or update date and time) of the logical volume, and so on are also written to the LV header “LV-HDR”.

A volume block “VOL1”, header blocks “HDR1” and “HDR2”, a data block “DATA”, end-of-file blocks “EOF1” and “EOF2”, and an end-of-volume block “EOV” are written to the logical volume region subsequent to the LV header “LV-HDR” in that order.

A volume name having the same value as the LV name in the LV header “LV-HDR” is written to the volume block “VOL1”. The file name, the update date and time, and so on of a file written to the data block “DATA” are written to the header block “HDR1”. The record format, the block length, and so on of the data block “DATA” are written to the header block “HDR2”.

The data block “DATA” is a variable-length user-data region. The file name, the update date and time, and so on of the file written to the data block “DATA” are written to the end-of-file block “EOF1”. The record format, the block length, and so on of the data block “DATA” are written to the end-of-file block “EOF2”. Mark information indicating the end of the volume is written to the end-of-volume block “EOV”.

On the other hand, a PV header “PV-HDR” is written to a start region on an export tape to which writing is performed in the ordinary export, and data transferred from the disk array apparatus 203 is written to a next region. Although not illustrated, a standard identifier “VOL1” of a physical volume, a PV name, a status indicating whether the magnetic tape is normal or abnormal, and so on are written to the PV header “PV-HDR”.

The standard identifier “VOL1” is name information of each magnetic tape, and is recorded to the start region of every magnetic tape, regardless of whether it is a library tape or an export tape. This standard identifier “VOL1” matches the tape name stated on the barcode label. The PV name recorded to the PV header “PV-HDR” also has the same value as the standard identifier “VOL1”. In the example in FIG. 7, the standard identifier “VOL1” and the PV name both have a value of “101”.

Data that is stored in the disk array apparatus 203 and that corresponds to a logical volume specified for the ordinary export is stored unmodified in a region next to the PV header “PV-HDR”. For example, when a request for the ordinary export of LV #001 and LV #002 is issued as illustrated in FIG. 7, the LV header “LV-HDR” of LV #001, LV #001, the LV header “LV-HDR” of LV #002, and LV #002 are sequentially written subsequent to the PV header “PV-HDR”.

A PV directory block “PV-DIR” is further written to a last region. In the PV directory block “PV-DIR”, for example, information of a block position in the magnetic tape with respect to each logical volume written thereto is written.

The export tape ejected as a result of execution of the ordinary export can be used unmodified in another virtual library system having the same specifications and can also be used again in the virtual library system from which the export tape was ejected. Thus, the format of the export tape ejected as a result of execution of the ordinary export has the same format as that of the library tapes in the virtual library system.

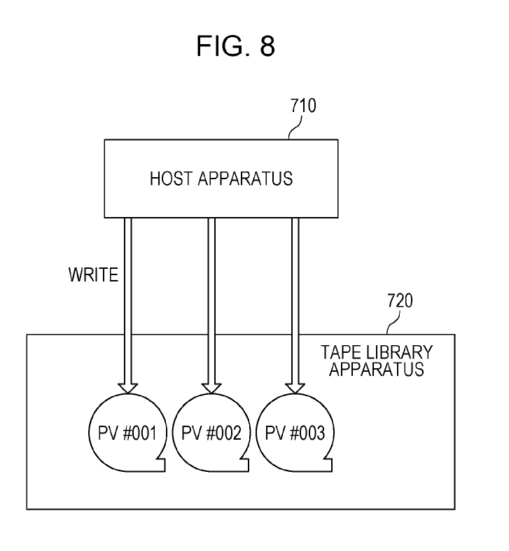

Next, before the native export is described, a description will be given of a library system configured such that a host apparatus directly accesses a library apparatus. FIG. 8 is a diagram illustrating an example of a library system.

The library system illustrated in FIG. 8 includes a host apparatus 710 and a tape library apparatus 720. Although the tape library apparatus 720 may have the same configuration as that of the tape library apparatus 300 illustrated in FIG. 5, the library system in FIG. 8 is different from the virtual library system in FIG. 5 in that the tape library apparatus 720 directly receives access from the host apparatus 710 without involvement of any virtual tape apparatus.

For example, the host apparatus 710 selects a magnetic tape having sufficient free area from the magnetic tapes in the tape library apparatus 720 and writes data to the selected magnetic tape. For example, when PV #001 in FIG. 8 is selected, the tape library apparatus 720 mounts PV #001 on the tape drive and issues a notification indicating that the mounting is completed to the host apparatus 710. Being triggered by reception of the mount completion notification, the host apparatus 710 writes data to PV #001.

Also, during reading of data, the host apparatus 710 issues, to the tape library apparatus 720, a notification specifying the PV name of the magnetic tape containing the data to be read. The tape library apparatus 720 mounts the specified magnetic tape on the tape drive and issues a notification indicating that the mounting is completed to the host apparatus 710. Being triggered by reception of the mount completion notification, the host apparatus 710 reads the data from mounted magnetic tape.

In such a library system, the host apparatus 710 directly recognizes each of the magnetic tapes, stored in the tape library apparatus 720, as a volume to be accessed. Thus, since the magnetic tapes and the volumes are associated with each other on a one-to-one basis, the volume name of each volume recorded on the magnetic tape has the same value as the tape name stated on the barcode label of the magnetic tape.

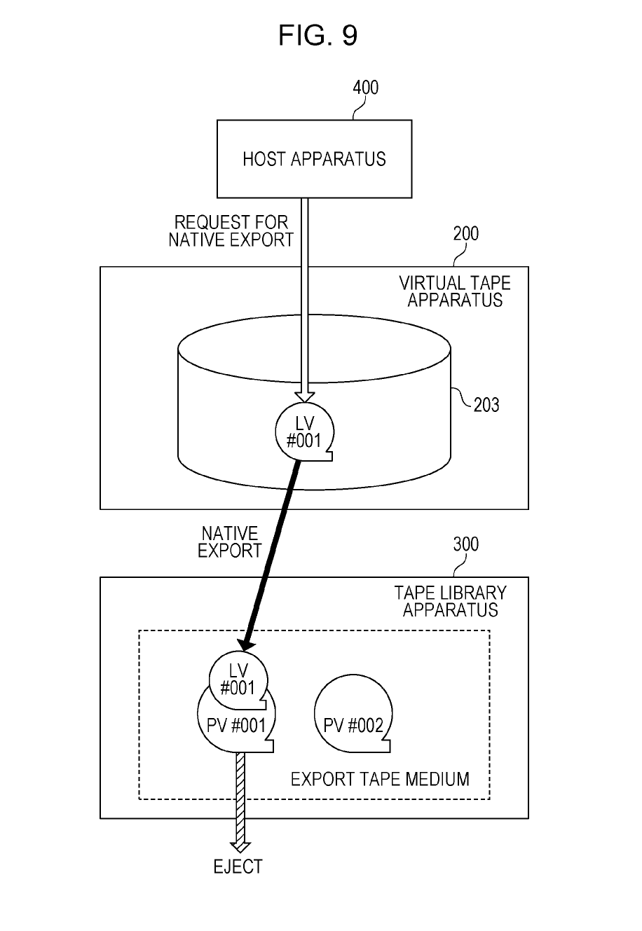

FIG. 9 is a diagram illustrating an overview of the native export. The native export is processing in which an export tape that can be used unmodified by a library apparatus directly accessed from a host apparatus is ejected, as in the tape library apparatus 720 illustrated in FIG. 8.

In the example in FIG. 9, it is assumed that the host apparatus 400 specifies LV #001 as a logical volume for the native export. In this case, the virtual tape apparatus 200 selects a magnetic tape (that is, PV #001) having the same PV name as the specified logical volume, LV #001, from among the export tapes prepared in the tape library apparatus 300.

The virtual tape apparatus 200 copies the specified logical volume, LV #001, from the disk array apparatus 203 to PV #001. When the specified logical volume, LV #001, is not stored in the disk array apparatus 203, the virtual tape apparatus 200 copies LV #001 to PV #001 after reading out LV #001 from a library tape to the disk array apparatus 203, as in the case of the ordinary export. When the copying is completed, PV #001 is ejected from the tape library apparatus 300.

Since it is important that the PV name of the magnetic tape to which a logical volume is to be written and the LV name of the logical volume to be written to the magnetic tape match each other, only one logical volume to be written is selected in the native export.

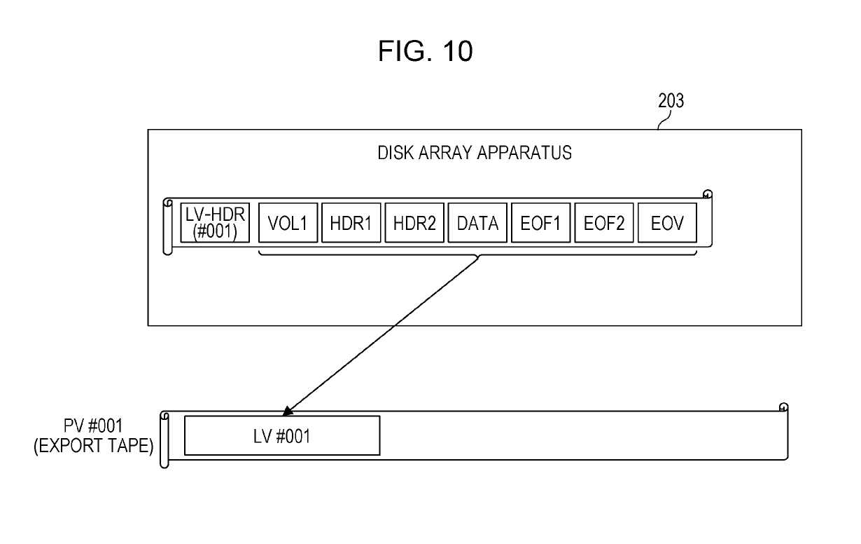

FIG. 10 illustrates an example of a data format in the native export. The example illustrated in FIG. 10 corresponds to a case in which LV #001 is copied to PV #001.

As described above, in the disk array apparatus 203, the data of LV #001 is stored subsequent to the LV header “LV-HDR” in which the LV name “001” for identifying LV #001 is recorded. When the native export is performed, only the region of LV #001 is copied to an export tape and the LV header “LV-HDR” is not copied thereto.

As a result, the volume block “VOL1” of LV #001 is placed in a start region on the export tape. The volume block “VOL1” plays the same role as the standard identifier “VOL1” recorded in the start region in the PV header “PV-HDR” illustrated in the example in FIG. 7. The LV name “001” recorded in the volume block “VOL1” matches the PV name “001” stated on the barcode label of PV #001.

The export tape in the state in which the tape name of the magnetic tape and the volume name of the volume on the magnetic tape match each other is generated as described above and is ejected from the tape library apparatus 300 to outside. The ejected export tape has the same format as that of the magnetic tapes stored in the tape library apparatus 720 illustrated in FIG. 8. Accordingly, the ejected export tape can be used in a library system as illustrated in FIG. 8.

Next, a description will be given of a problem in the native export.

As described above, it is important that, in the native export, the LV name of a logical volume to be written and the PV name of a magnetic tape to which the logical volume is to be written match each other. However, there may be cases in which copying to a magnetic tape having the same PV name as an LV name specified for the native export is not possible. For example, there are cases in which a fault occurs in a magnetic tape to which writing is to be performed and the copying is not continuable. In addition, there are also cases in which an export tape having the same PV name as a specified LV name is not stored in the tape library apparatus 300.

In the former case, the administrator generally has to retrieve the faulty magnetic tape from the tape library apparatus 300 and re-store, in the tape library apparatus 300, a normal magnetic tape to which a barcode label stating the same PV name is attached. In the latter case, the administrator also generally has to re-store, in the tape library apparatus 300, a normal magnetic tape to which a barcode label stating the same PV name as the specified LV name is attached. In either case, there is a problem that it takes a long time to resume the native export.

In contrast, even if copying to a magnetic tape having the same PV name as an LV name specified for the native export is not possible, the virtual tape apparatus 200 in the present embodiment continues the copying to the magnetic tape for as long as possible, to thereby increase the probability of execution of the native export.

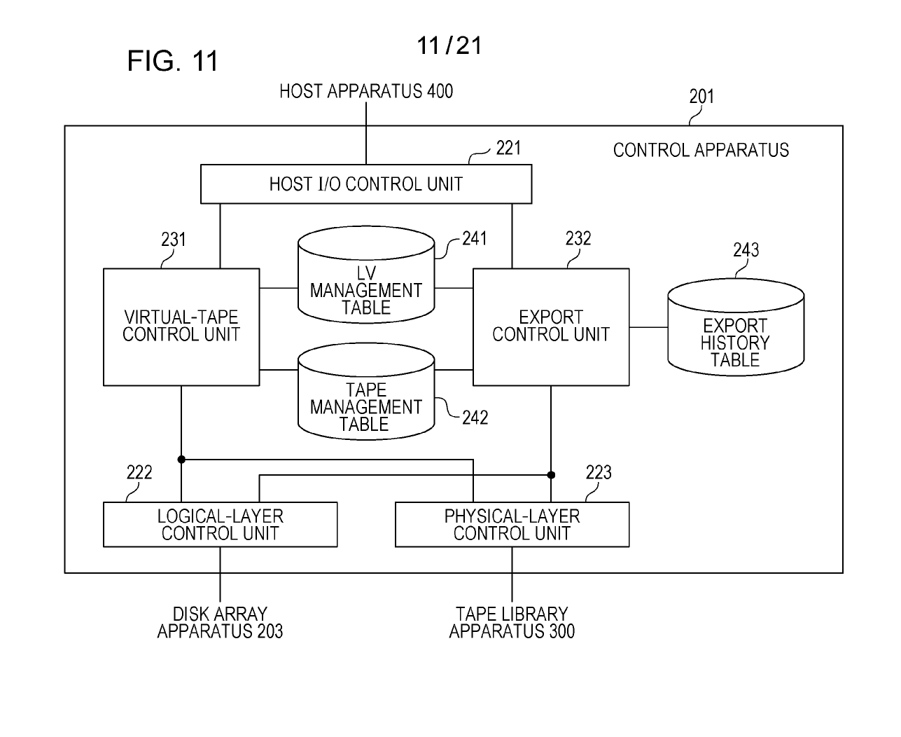

FIG. 11 is a block diagram illustrating an example of processing functions of the control apparatus. Although FIG. 11 illustrates the control apparatus 201, the control apparatus 202 also has functions that are the same as or similar to those of the control apparatus 201.

The control apparatus 201 includes a host I/O control unit 221, a logical-layer control unit 222, a physical-layer control unit 223, a virtual-tape control unit 231, and an export control unit 232. For example, the processor 211 in the control apparatus 201 executes a predetermined firmware program to thereby realize the processing of the host I/O control unit 221, the logical-layer control unit 222, the physical-layer control unit 223, the virtual-tape control unit 231, and the export control unit 232. The storage device (for example, the flash memory 213) included in the control apparatus 201 stores therein, for example, an LV management table 241, a tape management table 242, and an export history table 243.

Upon receiving, from the host apparatus 400, an I/O request for a logical volume, the host I/O control unit 221 causes the virtual-tape control unit 231 to execute the requested processing. When the I/O request is a read request, the host I/O control unit 221 notifies the virtual-tape control unit 231 of an LV name, a block number indicating a read range, and so on. The host I/O control unit 221 then receives data, read from the disk array apparatus 203, from the virtual-tape control unit 231 and transmits the received data to the host apparatus 400. When the I/O request is a write request, the host I/O control unit 221 notifies the virtual-tape control unit 231 of an LV name, a block number indicating a write range, data to be written, and so on and causes the virtual-tape control unit 231 to execute writing.

Also, upon receiving an ordinary-export request or a native-export request from the host apparatus 400, the host I/O control unit 221 causes the export control unit 232 to execute the requested processing. At this time, the host I/O control unit 221 receives an LV name specified for a logical volume to be exported and notifies the export control unit 232 of the specified LV name.

The logical-layer control unit 222 controls data transmission/reception between the virtual-tape control unit 231 or the export control unit 232 and the disk array apparatus 203. More specifically, in response to a request from the virtual-tape control unit 231 or the export control unit 232, the logical-layer control unit 222 reads data from the disk array apparatus 203 or writes data to the disk array apparatus 203.

The physical-layer control unit 223 controls data transmission/reception between the virtual-tape control unit 231 or the export control unit 232 and the magnetic tapes in the tape library apparatus 300. More specifically, in response to a request from the virtual-tape control unit 231 or the export control unit 232, the physical-layer control unit 223 reads data from any of the magnetic tapes or writes data to any of the magnetic tapes.

In response to a request from the virtual-tape control unit 231 or the export control unit 232, the physical-layer control unit 223 controls operations of the tape library apparatus 300. Examples of the operations include mounting, unmounting, transportation, and ejection of the tape cartridges.

The virtual-tape control unit 231 controls the operation of the virtual tape library system in which the disk array apparatus 203 is used as a primary storage (a cache device) and storage areas realized by library tapes in the tape library apparatus 300 are used as a secondary storage (a back-end).

For example, the virtual-tape control unit 231 generates a logical volume and receives access that the host apparatus 400 makes to the logical volume. In this case, the virtual-tape control unit 231 reserves an area for the logical volume in the disk array apparatus 203 and writes/reads, to/from the logical volume in the disk array apparatus 203, data corresponding to a request from the host apparatus 400.

The virtual-tape control unit 231 also writes the logical volume in the disk array apparatus 203 to an arbitrary one of the library tapes in the tape library apparatus 300. One example of such writing (migration) is processing for copying a logical volume in the disk array apparatus 203 to a library tape at a predetermined timing, such as at regular intervals. There is also processing for moving a logical volume having the oldest last-access time from the disk array apparatus 203 to a library tape when the disk array apparatus 203 does not have sufficient free space. In any processing described above, in migration performed by the virtual-tape control unit 231, a library tape having an arbitrary PV name is selected as a tape to which writing is to be performed.

When a logical volume for which a read request is issued from the host apparatus 400 is not stored in the disk array apparatus 203, the virtual-tape control unit 231 causes a library tape on which the logical volume is recorded to be mounted on any of the tape drives 311 to 314 in the tape library apparatus 300. The virtual-tape control unit 231 then reads the logical volume from the mounted library tape 311, 312, 313, or 314, stores the read logical volume in the disk array apparatus 203, reads data for which the read request was issued from the logical volume in the disk array apparatus 203, and transmits the read data to the host apparatus 400.

The virtual-tape control unit 231 uses the LV management table 241 to manage the logical volumes and uses the tape management table 242 to manage the library tapes.

In response to a request from the host apparatus 400, the export control unit 232 controls the processing for the ordinary export or the native export. For example, upon receiving an ordinary-export request from the host apparatus 400, the export control unit 232 copies one or more specified logical volumes from the disk array apparatus 203 to an arbitrary one of the export tapes in the tape library apparatus 300.

Also, upon receiving a native-export request from the host apparatus 400, the export control unit 232 copies a specified logical volume from the disk array apparatus 203 to an export tape having the same PV name as the LV name of the specified logical volume. Processing when copying to an export tape having the same PV name as the LV name of a specified logical volume is not possible is described later.

In either of the cases of the ordinary export and the native export, when a specified logical volume is not stored in the disk array apparatus 203, the export control unit 232 causes a library tape on which the logical volume is recorded to be mounted on any of the tape drives 311 to 314 in the tape library apparatus 300. The export control unit 232 then reads the logical volume from the mounted library tape 311, 312, 313, or 314, temporarily stores the logical volume in the disk array apparatus 203, and copies the stored logical volume to an export tape.

The export control unit 232 also records execution history of the ordinary export and native export to the export history table 243.

Next, a description will be given of the LV management table 241, the tape management table 242, and the export history table 243.

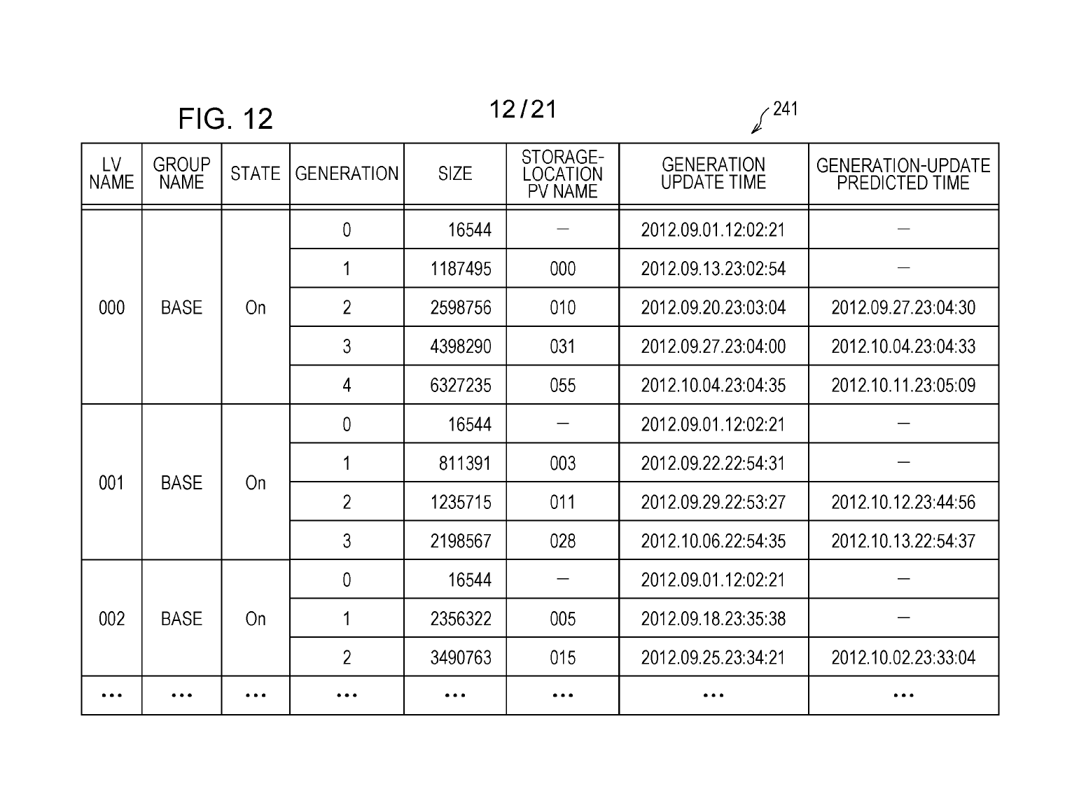

FIG. 12 illustrates an example of information registered in the LV management table 241. The LV management table 241 is a table for holding information regarding logical volumes created and managed in the virtual tape library system. The LV management table 241 has fields for an “LV name”, “group name”, “state”, “generation”, “size”, “storage-location PV name”, “generation update time”, and “generation-update predicted time”.

In the “LV name” fields, the identification numbers (the above-described LV names) of logical volumes generated by the virtual-tape control unit 231 are registered. In the LV management table 241, the identification numbers registered in the “LV name” fields are unique numbers that are different from one another.

In the “group name” fields, identifiers of groups to which corresponding logical volumes belong are registered. There are “BASE” and “NTV_EXPT” as the identifiers of the groups. “BASE” indicates an ordinary logical volume to be accessed from the host apparatus 400. “NTV-EXPT” indicates a logical volume temporarily generated for only the native export. Logical volumes belonging to “NTV_EXPT” are described later.

In each “state” field, information indicating whether or not the corresponding logical volume is stored in the disk array apparatus 203 is registered. When the corresponding logical volume is stored in the disk array apparatus 203 (that is, on cache state), “On” is registered in the “state” field, and when the corresponding logical volume is not stored (that is, off cache state), “Off” is registered in the “state” field. Based on the “state” field, the virtual-tape control unit 231 and the export control unit 232 may determine whether or not a desired logical volume is stored in the disk array apparatus 203.

When a logical volume indicated in the “LV name” field is created for the first time, one record for the “generation” field, the “size” field, the “storage-location PV name” field, the “generation update time” field, and the “generation-update predicted time” field is created in the LV management table 241. The created record is then added to the corresponding “LV name” field, each time the corresponding logical volume is written from the disk array apparatus 203 to a library tape.

A numerical value indicating the generation of the corresponding logical volume is registered in the “generation” field. An initial value of the numerical value is “0”, and the logical volume in generation “0” indicates that this logical volume is one created for the first time. When the corresponding logical volume is written from the disk array apparatus 203 to a library tape and a record for the “generation” field, the “size” field, the “storage-location PV name” field, the “generation update time” field, and the “generation-update predicted time” field is added, the numerical value in the “generation” field in the added record is incremented by “1”. Hence, the numerical value in the “generation” field indicates the number of updates of the logical volume stored in the secondary storage.

In each “size” field, the size of the logical volume in the corresponding generation is registered.

The PV name of a library tape to which the logical volume in the corresponding generation is written is registered in the “storage-location PV name” field. Based on the “storage-location PV name” field, the virtual-tape control unit 231 and the export control unit 232 may search for a library tape on which a desired logical volume is stored. When the numerical value of the corresponding generation is “0”, no numerical value is registered in the “storage-location PV name” field.

Only one “storage-location PV name” field may also be associated with each “LV name” field. In this case, the PV name of a library tape to which the corresponding logical volume in the latest generation is written is registered in the “storage-location PV name” field.

The update time of the logical volume in the corresponding generation is registered in the “generation update time” field. When the numerical value of the corresponding generation is “0”, the numerical value in the “generation update time” field indicates the time when the logical volume was created for the first time. When the numerical value of the corresponding generation is “1” or more, the numerical value in the “generation update time” field indicates the time at which the corresponding logical volume was written to a library tape.

The predicted time at which the corresponding logical volume is written to a library tape next time is registered in the “generation-update predicted time” field. The export control unit 232 determines the predicted time, based on the update time registered in the “generation update time” field for each generation prior to the corresponding generation. Thus, only when the numerical value in the corresponding “generation” field is “2” or more, the predicted time is registered in the “generation-update predicted time” field.

The predicted time registered in the “generation-update predicted time” field is determined, for example, in the following manner. The export control unit 232 calculates a time difference between the value in the “generation update time” field for the corresponding generation and the value in the “generation update time” field for the generation immediately preceding the corresponding generation and adds the calculated time difference to the value in the “generation update time” field for the corresponding generation. The export control unit 232 registers the resulting addition value in the “generation-update predicted time” field.

In another example, the export control unit 232 determines, for each generation, difference values in the value in the “generation update time” field between the adjacent generations and calculates an average of the determined difference values. The export control unit 232 adds the calculated average value to the value in the “generation update time” field for the corresponding generation and registers the resulting addition value in the “generation-update predicted time” field.

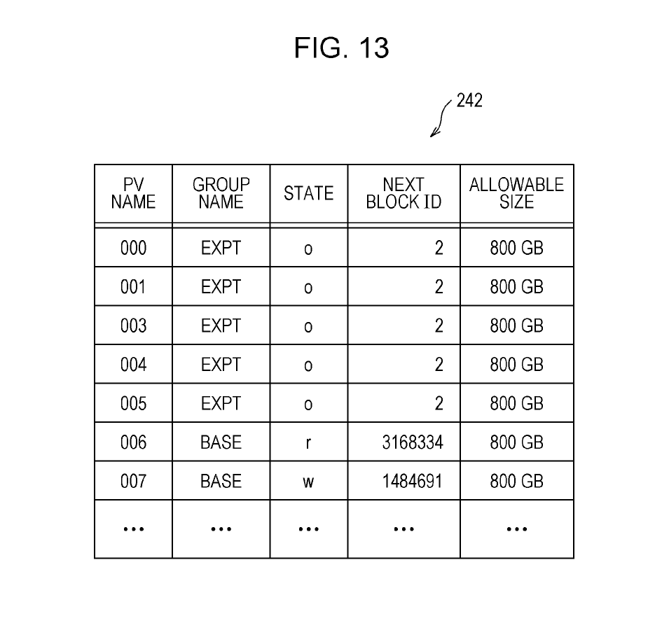

FIG. 13 illustrates an example of information registered in the tape management table 242. The tape management table 242 is a table for holding information regarding magnetic tapes stored in the tape library apparatus 300. The tape management table 242 has fields for a “PV name”, “group name”, “state”, “next block ID”, and “allowable size”.

In the “PV name” fields, the identification numbers (the above-described PV names) of the magnetic tapes stored in the tape library apparatus 300 are registered. The identification numbers registered in the “PV name” fields in the tape management table 242 are unique numbers that are different from one another regardless of whether the magnetic tapes are library tapes or export tapes.

In each “group name” field, identification information indicating whether or not the corresponding magnetic tape is a library tape or an export tape is registered. In the case of a library tape, “BASE” is registered, and in the case of an export tape, “EXPT” is registered.

In each “state” field, information indicating the state of the corresponding magnetic tape is registered. When the corresponding magnetic tape is in a scratch state (an empty state), “o” is registered in the “state” field. When the remaining capacity of the corresponding magnetic tape is larger than or equal to a predetermined amount and has enough space to write data, “w” is registered in the “state” field. When the remaining capacity of the corresponding magnetic tape is smaller than the predetermined amount and has no space to write any more data, “r” indicating “read only” is registered in the “state” field. When the corresponding magnetic tape is in an unwritable state because of a fault or the like, “f” indicating “faulty” is registered in the “state” field.

In each “next block ID” field, the block ID of the end of a written area on the corresponding magnetic tape is registered.

In each “allowable size” field, a numerical value indicating the capacity of the corresponding magnetic tape is registered. Which of the values “o”, “w”, and “r” is to be registered in the “state” field is determined based on the values registered in the “allowable size” field and the “next block ID” field.

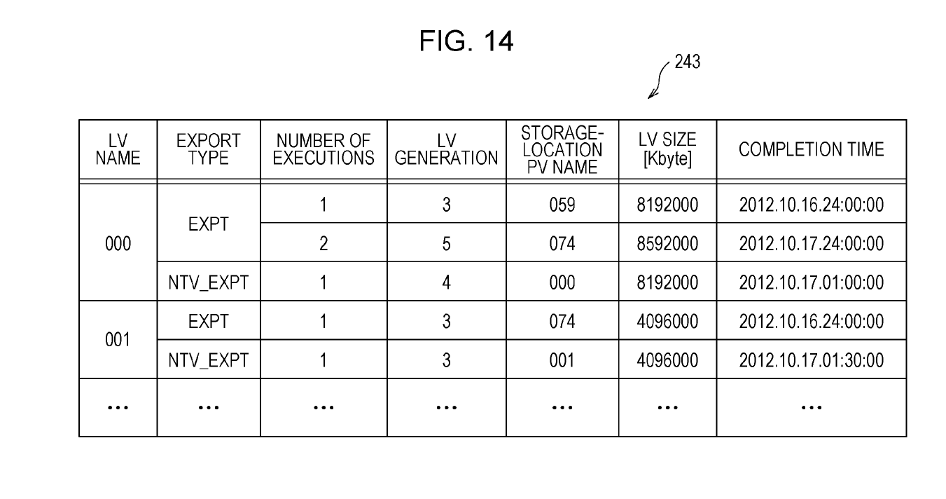

FIG. 14 illustrates an example of information registered in the export history table 243. The export history table 243 is a table for holding the execution history of the ordinary export and the native export. Each time the export control unit 232 executes the ordinary export or the native export, the export history table 243 is updated. The export history table 243 has fields for an “LV name”, “export type”, “number of executions”, “LV generation”, “storage-location PV name”, “LV size”, and “completion time”.

In each “LV name” field, the identification number of a logical volume is registered.

In the “export type” field, information indicating whether executed processing is the ordinary export or native export is registered. In the case of the ordinary export, “EXPT” is registered, and in the case of the native export, “NTV_EXPT” is registered.

When the ordinary export of a corresponding logical volume is executed even once, the record in the “export type” field in which “EXPT” is registered is associated with one “LV name” field. When the native export of a corresponding logical volume is executed even once, a record in the “export type” in which “NTV_EXPT” is registered is associated with one “LV name” field.

In each “number of executions” field, a numerical value indicating the number of times the ordinary export or native export of the corresponding logical volume has been executed is registered.

In each “LV generation” field, a numerical value indicating the generation of a logical volume on which the ordinary export or native export has been executed is registered. The numerical value indicating the generation is determined based on the value registered in the “generation” field in the LV management table 241.

In each “storage-location PV name” field, the PV name of an export tape to which writing is performed in the ordinary export or native export is registered.

In each “LV size” field, the size of the corresponding logical volume written to the export tape as a result of execution of the ordinary export or native export is registered.

In each “completion time” field, the completion time of writing the corresponding logical volume in the ordinary export or native export is registered. In the case of the ordinary export, the time at which the writing of all logical volumes specified for the ordinary export is completed may also be registered in the “completion time” field.

Next, processing performed by the control apparatus 201 during execution of the native export will be described with reference to mainly flowcharts.

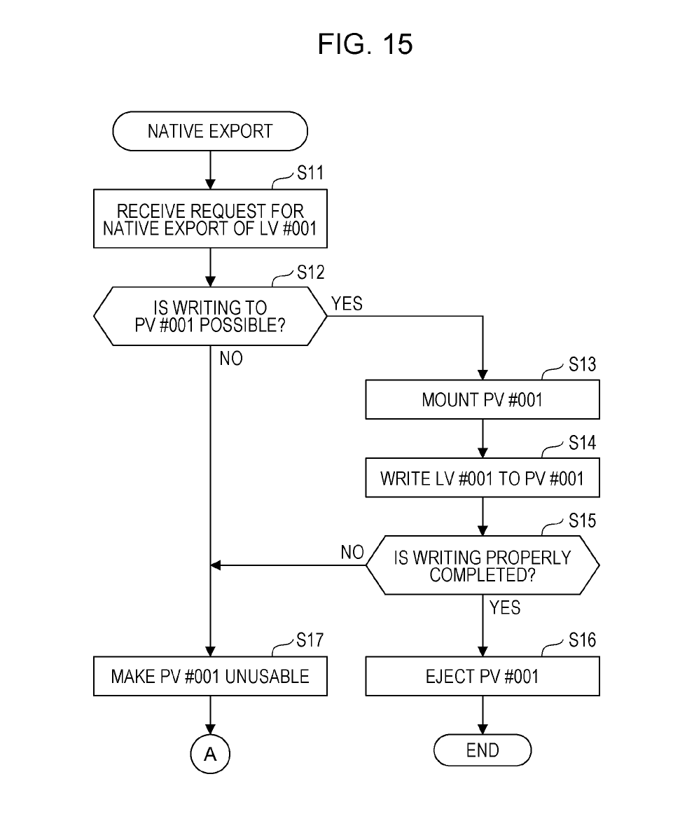

FIG. 15 is a first flowchart illustrating example processing performed by the control apparatus 201 during execution of the native export.

In step S11, the host I/O control unit 221 receives a native-export execute request from the host apparatus 400. The host I/O control unit 221 notifies the export control unit 232 of an LV name specified as a logical volume for the native export and requests the export control unit 232 to execute the native export.

The following description will be given assuming that LV #001 is specified as the logical volume for the native export, by way of example.

In step S12, the export control unit 232 determines whether or not writing to an export tape (PV #001) having the same PV name “001” as the specified LV name is possible. More specifically, by referring to the tape management table 242, the export control unit 232 makes a determination as follows.

The export control unit 232 determines whether or not a record in which “001” is registered in the “PV name” field, “EXPT” is registered in the “group name” field, and “o” is registered in the “state” field exists in the records in the tape management table 242. If a record that matches those conditions exists, it is determined that writing to the export tape with the PV name “001” is possible.

If it is determined that the writing is possible, the process in step S13 is executed. On the other hand, if it is determined that the writing is not possible, the process in step S17 is executed.

In step S13, the export control unit 232 issues, to the tape library apparatus 300 via the physical-layer control unit 223, a request for mounting PV #001. In response to the mount request, the tape library apparatus 300 mounts PV #001 on any of the tape drives 311 to 314.

In step S14, the export control unit 232 reads LV #001 from the disk array apparatus 203 and writes LV #001 to PV #001.

More specifically, the export control unit 232 determines whether or not LV #001 is stored in the disk array apparatus 203, by referring to, of the records in the LV management table 241, the records in which “001” is registered in the “LV name” field, and based on the “state” field. When LV #001 is stored in the disk array apparatus 203, the export control unit 232 reads LV #001 from the disk array apparatus 203 via the logical-layer control unit 222. The export control unit 232 transfers the read LV #001 to the tape library apparatus 300 via the physical-layer control unit 223 and requests the tape library apparatus 300 to write LV #001 to PV #001.

On the other hand, when LV #001 is not stored in the disk array apparatus 203, the export control unit 232 refers to a record in which the numerical value in the “generation” field is the largest among the records for the corresponding logical volume in the LV management table 241. The export control unit 232 reads the PV name from the “storage-location PV name” field in the record and issues, to the tape library apparatus 300 via the physical-layer control unit 223, a request for mounting a library tape having the read PV name.

When the corresponding library tape is mounted on the tape drive, the export control unit 232 reads LV #001 from the mounted library tape via the physical-layer control unit 223 and stores LV #001 in the disk array apparatus 203 via the logical-layer control unit 222. In this case, the export control unit 232 updates the value in the “state” field for LV #001 in the LV management table 241 from “Off” to “On”. When LV #001 is stored in the disk array apparatus 203, the export control unit 232 writes LV #001 from the disk array apparatus 203 to PV #001 in accordance with a procedure similar to that described above.

When LV #001 is written to PV #001, the LV header “LV-HDR” in which the LV name “001” is recorded is not written to PV #001, and only data in the subsequent area of LV #001 is written to PV #001, as described above with reference to FIG. 10.

In step S15, the export control unit 232 determines whether or not the writing of LV #001 to PV #001 is completed properly. For example, when a notification indicating an error or abnormal termination of writing to PV #001, detection of a fault in PV #001, or the like is received from the tape library apparatus 300, it is determined that the writing is not completed properly.

If the writing is properly completed, the process in step S16 is executed. On the other hand, if the writing is not properly completed, the process in step S17 is executed.

In step S16, the export control unit 232 issues, to the tape library apparatus 300 via the physical-layer control unit 223, a request for ejecting PV #001. As a result, the magnetic tape on which LV #001 is recorded in a format usable by the tape library apparatus 720 illustrated in FIG. 8 is ejected from the tape library apparatus 300 to outside.

The export control unit 232 also deletes the record for the ejected PV #001 from the tape management table 242.

The export control unit 232 also registers, in the export history table 243, history information indicating that the native export for writing LV #001 to PV #001 has been executed. More specifically, history information indicating the numerical value of the latest generation of LV #001, the numerical value being registered in the “generation” field in the LV management table 241, is registered in the “LV generation” field in the export history table 243.

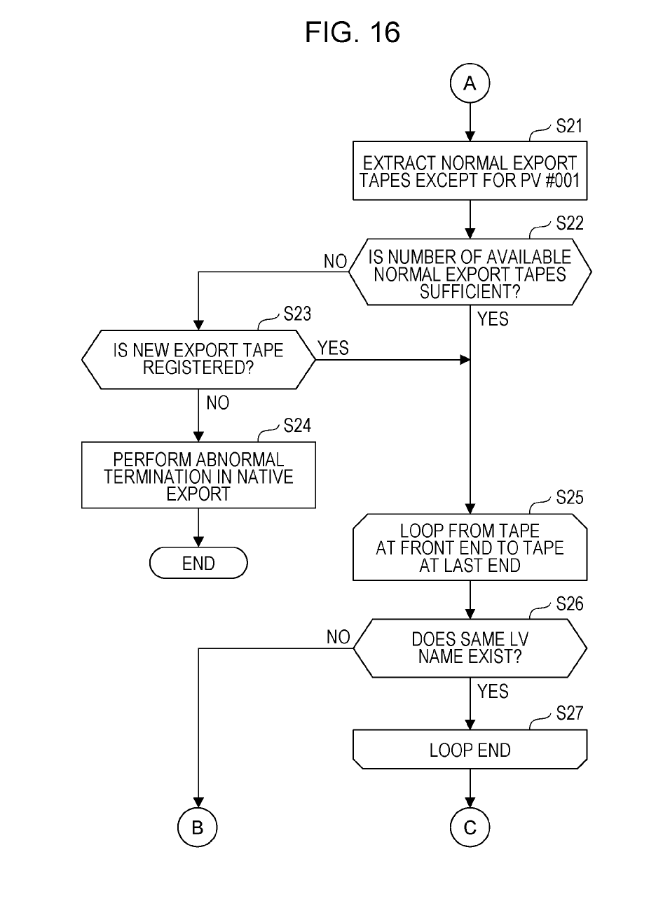

In step S17, the export control unit 232 updates the value in the “state” field for PV #001 in the tape management table 242 to “f” to make PV #001 unusable. Also, if an abnormality occurs during the process of writing to PV #001, that is, if the result of the determination in step S15 is NO, the export control unit 232 causes PV #001 to be unmounted from the tape drive. Thereafter, the process in step S21 in FIG. 16 is executed.

If “f” is registered in the “state” field for PV #001 in the tape management table 242 or PV #001 is not stored in the tape library apparatus 300 at the time of execution of step S12, the process in step S17 is skipped.

FIG. 16 is a second flowchart illustrating example processing performed by the control apparatus 201 during execution of the native export.

The processes in FIG. 16 and processes subsequent thereto are executed if it is determined that the writing to PV #001 is not possible, that is, if the result of the determination in either of steps S12 and S15 in FIG. 15 is NO. Even if it is determined that the writing to PV #001 is not possible, the control apparatus 201 performs the processes in FIG. 16 and processes subsequent thereto without immediately issuing a response indicating abnormal termination to the host apparatus 400, so as to complete the native export as much as possible.

In step S21, the export control unit 232 extracts all of the PV names of the normal magnetic tapes, that is, the magnetic tapes that are writable, except for PV #001, from the export tapes stored in the tape library apparatus 300. More specifically, the export control unit 232 reads, from the tape management table 242, all of the PV names of magnetic tapes for which “EXPT” is registered in the “group name” fields and “o” is registered in the “state” fields.

In step S22, the export control unit 232 determines whether or not the number of available normal export tapes is sufficient. If it is determined that the number of available normal export tapes is sufficient, the process in step S25 is executed. On the other hand, if it is determined that the number of available normal export tapes is not sufficient, the process in step S23 is executed.

In the determination in step S22, based on the history information recorded in the export history table 243, the export control unit 232 estimates the number of export tapes to be used for execution of the ordinary export and native export per unit period. The export control unit 232 then compares the estimated value with the number of normal export tapes extracted in step S21. Based on the result of the comparison, the export control unit 232 determines whether or not the native export and ordinary export predicted in the remaining period in the unit period can be executed even if the extracted normal export tape(s) are used now for the native export.

The determination process in step S22 will now be described assuming that the unit period used for the determination is one day (24 hours) and the boundary of the unit period is 12:00 a.m. In this case, it may be assumed that, at 12:00 a.m., the tape library apparatus 300 is refilled with export tapes.

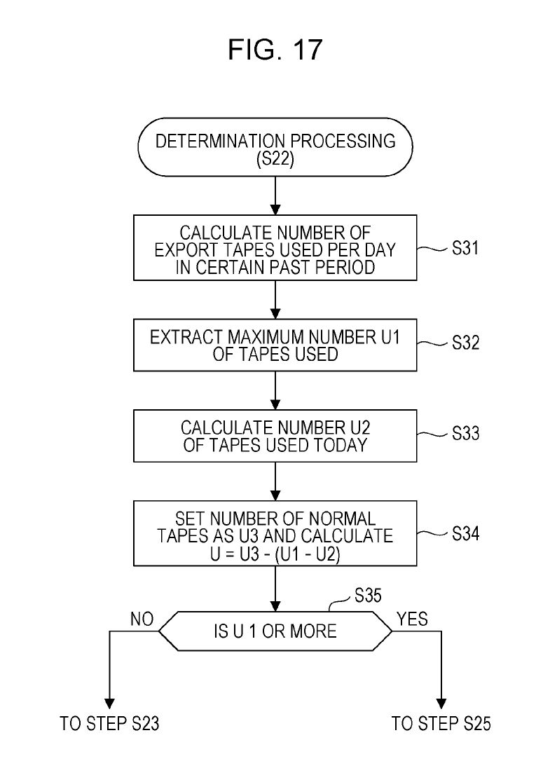

FIG. 17 is a flowchart illustrating an example of the processing for determining whether or not the number of available export tapes is sufficient.

In step S31, the export control unit 232 refers to the history information of a certain past period (for example, one week), except for today, the history information being recorded in the export history table 243. Based on the history information of the certain past period, the export control unit 232 calculates, for each day, the number of export tapes used per day.

The number of export tapes used per day is calculated, for example, as follows. The export control unit 232 extracts, from the export history table 243, records in which the times on the same day are registered in the “completion time” fields. The number of records extracted at this point is indicated by R1. The export control unit 232 further extracts, from the extracted records, records in which the same PV name is registered in the “storage-location PV name” fields, leaves only one of the extracted records, and excludes the remaining record(s). The number of records excluded at this point is indicated by R2. The export control unit 232 calculates R1−R2 as the number of export tapes used in that day.

In step S32, the export control unit 232 extracts a maximum number U1 from among the numbers of export tapes used per day, the numbers being calculated in step S31. In step S32, an average number may also be calculated instead of the maximum number U1.

In step S33, based on the history information recorded in the export history table 243, the export control unit 232 calculates the number of export tapes used from 12:00 a.m. today up to the present time (the number is referred to as the “number U2 of tapes used today”). A calculation method that is similar to the method for calculating the number of export tapes used per day in step S31 may be used to calculate the number U2 of tapes used today, by using records in which today's time is registered in the “completion time” fields among the records in the export history table 243.

In step S34, the export control unit 232 sets, as U3, the number of normal export tapes presently stored in the tape library apparatus 300, that is, the number of normal export tapes extracted in step S21 in FIG. 16. The export control unit 232 calculates the number U of remaining tapes by using equation (1).

U=U3−(U1−U2) (1)

The number U of remaining tapes indicates, when the predicted maximum number U1 of export tapes except for the native export to be presently executed are used today for execution of the ordinary export and native export, the number of other remaining ordinary export tapes.

In step S35, the export control unit 232 determines whether or not the determined number U of remaining tapes is one or more. If the number U of remaining tapes is one or more, it is determined that the number of available export tapes is sufficient, and the process in step S25 in FIG. 16 is executed. On the other hand, if the number U of remaining tapes is less than one, it is determined that the number of available export tapes is not sufficient, and the process in step S23 in FIG. 16 is executed.

The determination threshold used in the determination in step S35 may be two or more. For example, when the average number, instead of the maximum number U1, is calculated in step S32, it is desirable that the determination threshold used in the determination in step S35 have a large value to some extent.

Now, an example of the above-described determination processing will be described using specific values. By way of example, it is assumed that, in step S32, the maximum number (U1) of export tapes used per day in the last one week is 10. It is also assumed that the number (U2) of export tapes used from 12.00 a.m. today to the present time is 6. In this case, there is a possibility that four export tapes are used in the remaining period today.

Even if the native export to be presently executed is executed when the number (U3) of normal export tapes stored in the tape library apparatus 300 and extracted in step S21 in FIG. 16 is five or more, four export tapes can be further used in the remaining period today. Thus, it is determined that the number of available export tapes is sufficient.

On the other hand, if the native export to be presently executed is executed when the number (U3) of normal export tapes stored in the tape library apparatus 300 is four, the four export tapes are not usable in the remaining period today. Thus, it is determined that the number of available export tapes is not sufficient.

The determination threshold used in step S35 may also be zero. Since the ordinary export and the native export are one type of backup processing, the intervals of the execution thereof have regularity in many cases. It may also be considered that the native export for which an execute request is presently issued is also executed regularly. In such a case, even when the determination threshold used in step S35 is zero, it is possible to accurately determine whether or not the number of available normal export tapes is sufficient.

A description will be given with reference back to FIG. 16.

If the number of available normal export tapes stored in the tape library apparatus 300 is not sufficient (NO in step S22), it is not appropriate to perform writing to one of the normal export tapes. Accordingly, in step S23, the export control unit 232 gives a grace period for adding an export tape to the tape library apparatus 300.

For example, the export control unit 232 causes the display device of the management terminal 500 to display a message for querying whether or not to add a new export tape and waits for a response from the management terminal 500. The message may also be presented to the host apparatus 400 that has issued a corresponding native-export request.

For example, when a response indicating “add” is received from the management terminal 500 within a predetermined time, the export control unit 232 waits for a new export tape to be added to the tape library apparatus 300. The work for adding the export tape is performed by, for example, the administrator. When a new export tape is stored in the tape library apparatus 300 and information about the added export tape is registered in the tape management table 242 in response to the administrator's operation on the management terminal 500, the process in step S25 is performed.

When the PV name of the added export tape is “001”, the process in step S13 in FIG. 15 may be executed rather than the process in step S25.

On the other hand, when a response indicating “not add” or no response is received from the management terminal 500 within the predetermined time after the message for querying whether or not to add an export tape is displayed, the process in step S24 is executed.

In step S24, the export control unit 232 transmits, to the host apparatus 400 via the host I/O control unit 221, a message indicating that abnormal termination has performed in the native export. Thereafter, the export control unit 232 ends the processing.

If the number of available normal export tapes stored in the tape library apparatus 300 is sufficient (YES in step S22) or a new export tape is added to the tape library apparatus 300 (YES in step S23), then one of the normal export tapes extracted in step S21 is selected and writing to the selected export tape is performed in the process in step S25 and steps subsequent thereto.

More specifically, in step S25, the export control unit 232 creates a list of the normal export tapes and executes the processes up to the loop end, that is, up to step S27, on each of the export tapes in the list. The term “normal export tapes” as used herein refers to the export tapes extracted in step S21, when the result of the determination in step S22 is “YES”. If the result of the determination in step S23 is “YES”, the normal export tapes include the export tapes extracted in step S21 and the export tape added in step S23.

In step S26, the export control unit 232 determines whether or not a logical volume having the same LV name as the PV name of the export tape to be processed exists in the logical volumes registered in the LV management table 241.

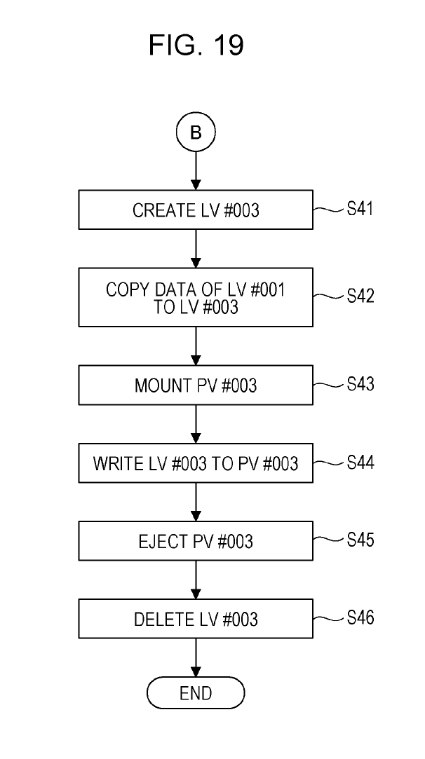

If a logical volume having the same LV name as the PV name of the export tape to be processed does not exist, the loop of the processes in steps S25 to S27 is finished, and the process in step S41 in FIG. 19 is executed. On the other hand, a logical volume having the same LV name as the PV name of the export tape to be processed exists, the process in step S27 is executed.

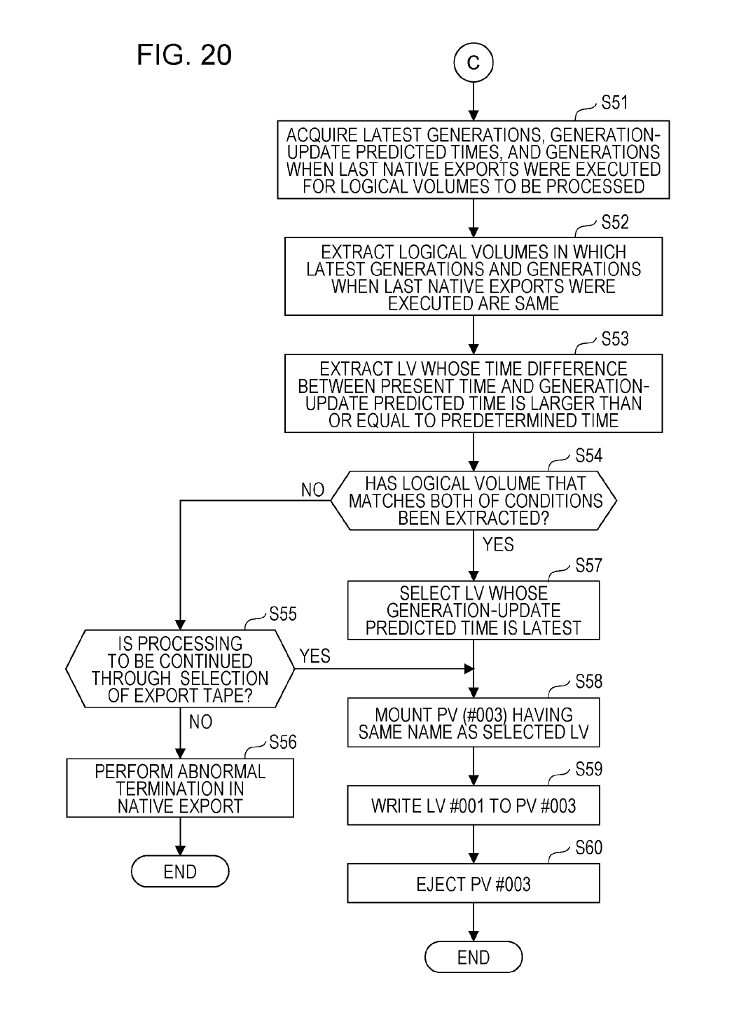

When the result of the determination in step S26 is “YES” with respect to all of the normal export tapes, the process proceeds to step S51 in FIG. 20 via step S27.

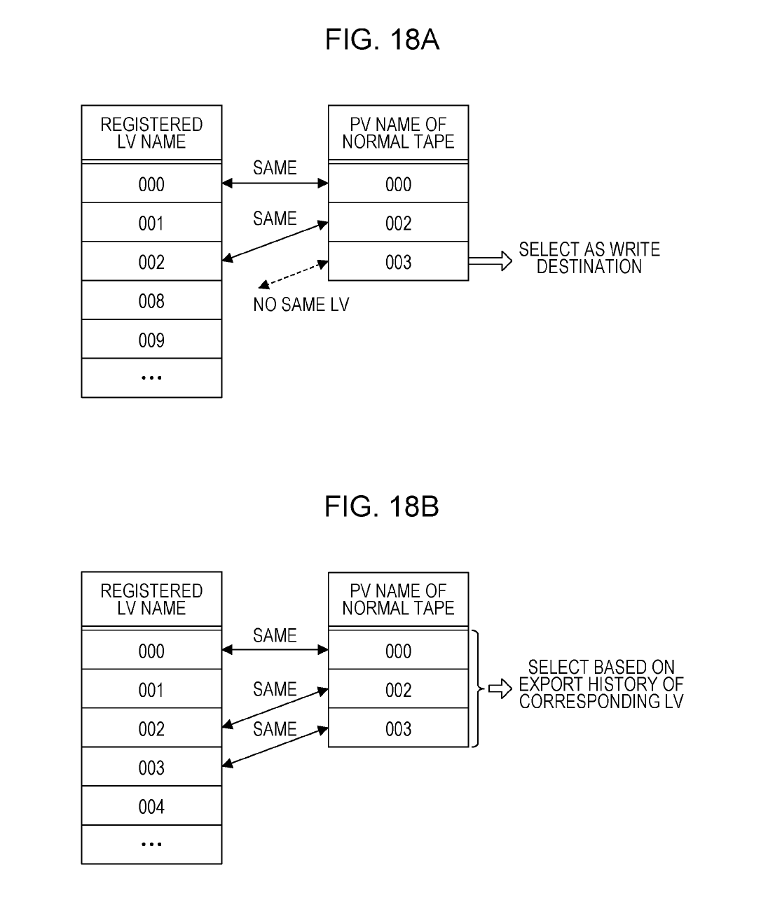

FIGS. 18A and 18B illustrate the processes in steps S25 to S27 and processes subsequent thereto.

In step S26 in FIG. 16, with respect to each of the normal export tapes, a determination is made as to whether or not a logical volume having the same LV name as the PV name of the normal export tape exists. When a logical volume having the same LV name as the PV name of the normal export tape exists, the export control unit 232 does not use the export tape as a write destination for the native export presently being requested for the execution. This is because it is preferable that the export tape be left so as to be usable as a write destination, when a request for the native export is issued for a logical volume having the same LV name as the PV name of the export tape.

FIGS. 18A and 18B illustrate an example of a list of the LV names of logical volumes, the LV names being registered in the LV management table 241, and a list of PV names of normal export tapes, the PV names being stored in the tape library apparatus 300. It is assumed that, in either of the cases in FIGS. 18A and 18B, PV #000, PV #002, and PV #003 are stored as normal export tapes.

In the example in FIG. 18A, LV #000 and LV #002 are registered in the LV management table 241, whereas LV #003 is not registered therein. In this case, when the physical volume to be processed is PV #003, it is determined in step S26 in FIG. 16 that a logical volume having the same name does not exist”.

In a case as in FIG. 18A, the export control unit 232 selects PV #003 as a write destination for the native export that is presently requested for the execution. Processing performed in this case corresponds to FIG. 19.

On the other hand, the export control unit 232 leaves PV #000 and PV #002 in the tape library apparatus 300 without selecting them as write destinations for the native export presently requested for the execution. This arrangement allows the native export to be properly executed using PV #000 or PV #002 as a write destination, when LV #000 or LV #002 is subsequently specified as a logical volume for the native export.

In the example in FIG. 18B, LV #000, LV #002, and LV #003 are registered in the LV management table 241. Thus, it is determined in step S26 in FIG. 16 that a logical volume having the same name exists with respect to all of the export tapes.

In this case, the export control unit 232 selects a write destination from PV #000, PV #002, and PV #003. However, based on the history information regarding LV #000, LV #002, and LV #003 which is recorded in the export history table 243, the export control unit 232 selects a write destination from PV #000, PV #002, and PV #003 so that an influence on the native export to be subsequently executed is the smallest. Processing in this case corresponds to FIG. 20.

FIG. 19 is a third flowchart illustrating example processing performed by the control apparatus 201 during execution of the native export.

The processing illustrated in FIG. 19 is executed when the result of the determination in step S26 in FIG. 16 is “NO”. In this case, by way of example, it is assumed that the result of the determination in step S26 is “NO” when the physical volume to be processed is PV #003. That is, it is assumed that LV #003 is not registered in the LV management table 241.

In step S41, the export control unit 232 creates LV #003 having the same LV name as the PV name of PV #003.

More specifically, the export control unit 232 generates a new record for LV #003 in the LV management table 241. A numeric value “003” is registered in the “LV name” field in the record. “NTV_EXPT” indicating that this record is temporarily generated for the native export is registered in the “group name” field. “On” is registered in the “state” field. The values registered in the “generation” and “size” fields for LV #001 of the latest generation are copied to the “generation” and “size” fields, respectively. Information may or may not be particularly registered in the other fields.

In step S42, the export control unit 232 reserves, in the disk array apparatus 203, a storage area for LV #003. The export control unit 232 writes an LV header “LV-HDR” stating the LV name “003” to a start area in the reserved storage area. In addition, the export control unit 232 copies the data of LV #001 of the latest generation to an area following the LV header “LV-HDR”. However, of those pieces of data, only the LV name of the volume block “VOL1” is rewritten from “001” to “003”.

Upon failing to reserve a storage area for LV #003 because of a shortage of the capacity of the disk array apparatus 203, the export control unit 232 issues a migrate request to the virtual-tape control unit 231. The virtual-tape control unit 231 moves, of the logical volumes on the disk array apparatus 203, the logical volume whose last-access time is the oldest to a library tape, to thereby increase the free space of the disk array apparatus 203.

In step S43, the export control unit 232 issues, to the tape library apparatus 300 via the physical-layer control unit 223, a request for mounting PV #003. As a result, PV #003 is mounted on any of the tape drives in the tape library apparatus 300.

In step S44, the export control unit 232 writes LV #003 in the disk array apparatus 203 to PV #003, in accordance with a procedure similar to step S14 illustrated in FIG. 15.

When the writing in step S44 is completed, the process proceeds to step S45 in which the export control unit 232 issues, to the tape library apparatus 300 via the physical-layer control unit 223, a request for ejecting PV #003. As a result, the magnetic tape on which LV #003 is recorded in the format usable by the tape library apparatus 720 illustrated in FIG. 8 is ejected from the tape library apparatus 300 to outside.

The export control unit 232 also deletes the record for the ejected PV #003 from the tape management table 242.

The export control unit 232 also registers, in the export history table 243, history information indicating that the native export has been executed. More specifically, history information indicating that the native export for LV #001 specified by the host apparatus 400 has been executed is registered in the export history table 243.

The export control unit 232 also notifies the management terminal 500 or the host apparatus 400 of information indicating that the native export with the volume name being changed has been executed and the changed volume name (“003”).

In step S46, the export control unit 232 deletes the record for LV #003 from the LV management table 241. The export control unit 232 also clears the data regarding LV #003 in the disk array apparatus 203.

Without copying the substantial data in LV #001 in step S42 described above, the data may also be directly written from the storage area of LV #001 to PV #003 in step S44. Such an arrangement reduces the processing time.

According to the processing illustrated in FIG. 19, although the PV name is changed from the LV name specified by the host apparatus 400, a magnetic tape on which the data of the specified logical volume is recorded in the format usable by the tape library apparatus 720 as in FIG. 8 is ejected. Accordingly, it is possible to complete the native export, even if writing to an export tape having the same PV name as the specified LV name is not possible.

FIG. 20 is a fourth flowchart illustrating example processing performed by the control apparatus 201 during execution of the native export. The processing illustrated in FIG. 20 is executed when the result of the determination in step S26 in FIG. 16 is “YES” with respect to all export tapes to be processed.

In FIG. 20, the processing is to be performed on a logical volume having the same LV name as the PV name of a normal export tape. In the example illustrated in FIG. 18B, the processing is to be performed on LV #000, LV #002, and LV #003.

The term “normal export tapes” as used herein refers to the export tapes extracted in step S21 in FIG. 16 when the result of the determination in step S22 is “YES”. When the result of the determination in step S23 is “YES”, the normal export tapes include the export tapes extracted in step S21 and the export tape added in step S23.

In step S51, with respect to the logical volumes to be processed, the export control unit 232 acquires, from the LV management table 241, the latest generations and the generation-update predicted times. Also, with respect to the logical volumes to be processed, the export control unit 232 acquires, from the export history table 243, the respective generations when the last native exports were executed.

In step S52, the export control unit 232 extracts, from the logical volumes to be processed, logical volumes in which the latest generations and the generations when the last native exports were executed are the same.

In step S53, the export control unit 232 further extracts, from the logical volumes extracted in step S52, a logical volume whose time difference between the present time and the generation-update predicted time is larger than or equal to a predetermined time.

In step S54, the export control unit 232 determines whether or not any logical volume that matches upper limits of both of the conditions in steps S52 and S53 has been extracted. When any logical volume that matches the upper limits has been extracted, the process in step S57 is executed. When no logical volume is extracted, the process in step S55 is executed.

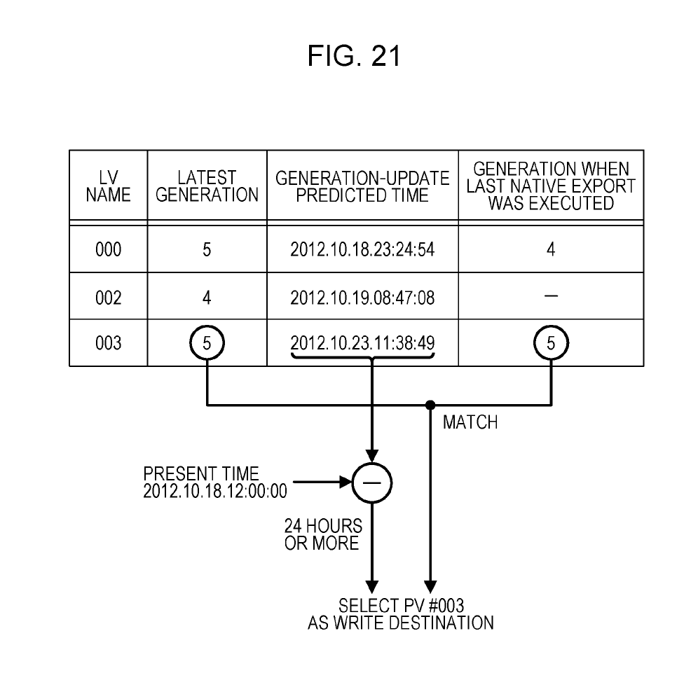

The processes in steps S51 to S54 described above will now be described in conjunction with a specific example. FIG. 21 is a table illustrating an example of acquired information.

In the example illustrated in FIG. 21, it is assumed that the latest generation of LV #000 is “5” and the generation when the last native export was executed on LV #000 is “4”. In this case, the native export has not been executed on LV #000 of the latest generation, and there is a high possibility that the native export of LV #000 of the latest generation is to be executed within a relatively short time in the future.

In this case, the export control unit 232 does not use PV #000 having the same LV name as the PV name of LV #000 at this point in time and leaves PV #000 in the tape library apparatus 300. This makes it possible to execute the native export using the left PV #000 during the native export of the latest generation LV #000 that is predicted to be executed within a relatively short time in the future.

On the other hand, it is also assumed that the latest generation of LV #003 is “5” and the generation when the last native export was executed on LV #003 was also “5”. In this case, the native export with respect to LV #003 in the latest generation has already been executed, and there is a low possibility that the native export of LV #003 in the same generation is executed again. Thus, it is presumable that the time until the native export of LV #003 is executed next time is longer than the time until the native export of LV #000 is executed next time. Accordingly, the export control unit 232 includes, in candidates of the write destination, PV #003 having the same PV name as the LV name of LV #003.

In the example illustrated in FIG. 21, the native export has not been executed on LV #002. In this case, it is difficult to predict the time until the native export of LV #002 is executed next time, PV #002 having the same PV name as the LV name of LV #002 is excluded from the candidates of the write destination.

Next, the export control unit 232 calculates a time difference between the present time and the generation-update predicted time of LV #003 and determines whether or not this time difference is larger than or equal to a predetermined time (for example, 24 hours). When the calculated time difference is larger than or equal to the predetermined time, the export control unit 232 decides that a sufficient amount of time is left until the native export of LV #003 is executed next time. In this case, the export control unit 232 determines that PV #003 having the same PV name as the LV name of LV #003 is selectable as a write destination.

In the processing described above, of the logical volumes to be processed, a logical volume that is estimated to have a sufficient amount of time until the native export is executed next time is appropriately determined in the two-stage determination processing using the values of the generations and the generation-update predicted times.

Now, a description will be given with reference back to FIG. 20.

When the result of the determination in step S54 is “NO”, this means that a logical volume estimated to have a sufficient amount of time until the native export is executed next time does not exist in the logical volumes to be processed. In this case, in step S55, the export control unit 232 causes the display device of the management terminal 500 to display a message for querying whether or not to continue the processing through selection of a write destination from the export tapes that do not match those conditions, and waits for a response from the management terminal 500. The message may also be presented to the host apparatus 400 that has issued a corresponding native-export request.

Upon receiving a response indicating “continue” from the management terminal 500 within a predetermined time after the message was presented, the export control unit 232 selects, from all of the logical volumes to be processed, for example, a logical volume whose generation-update predicted time is the latest. Thereafter, the process in step S58 is executed. On the other hand, when a response indicating “not continue” or no response is received from the management terminal 500 within the predetermined time after the message was presented, the export control unit 232 executes the process in step S56.

In step S56, the export control unit 232 transmits, to the host apparatus 400 via the host I/O control unit 221, a message indicating that abnormal termination has performed in the native export. Thereafter, the export control unit 232 ends the processing.

When a plurality of logical volumes that match both of the conditions are selected in step S54, the process proceeds to step S57 in which the export control unit 232 selects, from the selected logical volumes, a logical volume whose generation-update predicted time is the latest. When only one logical volume that matches both of the conditions is selected in step S54, this logical volume is directly selected.

In step S58, the export control unit 232 issues, to the tape library apparatus 300 via the physical-layer control unit 223, a request for mounting an export tape having the same PV name as the LV name of the selected logical volume. In this case, by way of example, it is assumed that a request for mounting PV #003 is issued. The tape library apparatus 300 mounts PV #003 on any of the tape drives.

In step S59, writing is performed to PV #003.

In this case, in order to ensure that PV #003 after the writing is completed becomes usable by the tape library apparatus 720 as in FIG. 8, it is important that the identification number of a volume to be written to PV #003 be “003” that is the same as the PV name. However, LV #003 having the same LV name as the PV name of PV #003 has already been registered in the LV management table 241 and is accessible from the host apparatus 400. Thus, creating another LV #003 by changing the LV name of LV #001 for which a native-export request is issued to “003”, as in the processing illustrated in FIG. 19, is not preferable for the system.

Accordingly, in step S59, a difference between the PV name of the export tape and the LV name of the logical volume to be recorded thereto is permitted exceptionally. The export control unit 232 reads LV #001 from the disk array apparatus 203 and writes LV #001 to PV #003 without changing the LV name. The procedure of this write processing is analogous to that in step S14 illustrated in FIG. 15.

When the writing in step S59 is completed, the process proceeds to step S60 in which the export control unit 232 issues, to the tape library apparatus 300 via the physical-layer control unit 223, a request for ejecting PV #003.

The export control unit 232 also deletes, from the tape management table 242, the record for the ejected PV #003.

The export control unit 232 also registers, in the export history table 243, history information indicating that the native export has been executed. More specifically, history information indicating that the native export for LV #001 specified by the host apparatus 400 has been executed is registered in the export history table 243.

The export control unit 232 also notifies the management terminal 500 or the host apparatus 400 that exceptional native export in which the PV name and the name of the recorded volume are different from each other has been performed.

According to the processes in steps S58 to S60 described above, control that gives higher priority to ejecting the export tape on which a logical volume for which a native-export request has been issued is performed, rather than reliably executing only the original native export. This arrangement makes it possible to reduce the probability of occurrence of an event in which processing is terminated in the middle thereof in response to a native-export request from the host apparatus 400 and no export tape is ejected.

With respect to the export tape ejected in step S60, the administrator may also relabel the barcode label stating the same PV name as the name of a recorded volume to thereby make it possible to make the export tape usable by the tape library apparatus 720 as in FIG. 8. In this sense, the processes in steps S58 to S60 can be said to better meet demands of a person who requests the native export than terminating the processing for the native export.

The processes in steps S58 to S60 may also be modified such that the LV name of LV #001 is changed to “003” and then writing to PV #003 is performed, as in the processes in steps S41 to S46 in FIG. 19. In this case, the arrangement is made so as to ensure that access from the host apparatus 400 to LV #003 temporarily created for the native export is blocked.

For example, when LV #003 for the native export is created, two records for LV #003 in the same generation are created in the LV management table 241. However, the pieces of information registered in the “group name” fields are different between the two records. More specifically, “BASE” is registered in the “group name” field in the originally registered record, and “NTV_EXPT” is registered in the “group name” field in the record added for the native export.

Accordingly, the virtual-tape control unit 231 is adapted to disregard the record in which “NTV_EXPT” is registered in the “group name” field, so that no access is made to a logical volume corresponding to the record. This arrangement blocks access from the host apparatus 400 to a logical volume temporarily created for the native export.

In the second embodiment described above, library tapes and export tapes are distinguished from each other in advance, and the write destinations for both of the ordinary export and the native export are limited to the export tapes. However, in another example, the library tapes and the export tapes may or may not be distinguished from each other. In such a case, it is sufficient to select, as the write destinations for the ordinary export and native export, unused magnetic tapes from the magnetic tapes stored in the tape library apparatus 300.

Processing functions of the apparatuses (the control apparatuses 3, 201, and 202, the host apparatuses 4 and 400, and the management terminal 500) in the embodiments described above may also be realized by computers. In such a case, a program in which the details of the processing of the functions to be included in each apparatus are written is supplied, and when the program is executed by the corresponding computer, the above-described processing functions are realized on the computer. The program in which the details of the processing are written may be recorded to a computer-readable recording medium. Examples of the computer-readable recording medium include a magnetic storage device, an optical disk, a magneto-optical recording medium, and a semiconductor memory. Examples of the magnetic storage device include a hard-disk device (HDD), a flexible disk (FD), and a magnetic tape. Examples of the optical disk include a digital versatile disc (DVD), a DVD-RAM, a compact disc read-only memory (CD-ROM), and a recordable/rewritable compact disk (CD-R/RW). One example of the magneto-optical recording medium is a magneto-optical (MO) disk.

For distribution of the program, for example, portable recording media (such as DVDs and CD-ROMs) on which the program is recorded may be made commercially available. The program may also be stored in a storage device in a server computer so as to allow the program to be transferred from the server computer to another computer over a network.

The computer that executes the program stores, in a storage device thereof, for example, the program recorded on a portable recording medium or the program transferred from the server computer. The computer then reads the program from the storage device thereof and executes processing according to the program. The computer may also directly read the program from a portable recording medium to execute processing according to the program. Each time the program is transferred from the server computer connected through a network, the computer may also receive the program and sequentially execute processing according to the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system composing:
a library apparatus that is configured to store a plurality of portable recording media in the library apparatus and to write and read data by using the stored portable recording media;
a storage apparatus; and
a control apparatus configured to control access to a plurality of logical volumes by using the storage apparatus as a first storage and using a storage area provided by the plurality of portable recording media as a second storage,
wherein, upon receiving a request for copying a first logical volume of the plurality of logical volumes, the control apparatus copies the first logical volume to an unused first recording medium included in the plurality of portable recording media and having the same identification number as an identification number of the first logical volume, when copying to the first recording medium is possible, and selects an unused second recording medium from the plurality of portable recording media, generates a second logical volume in which the identification number of the first logical volume is changed to the same identification number as an identification number of the second recording medium, and copies the generated second logical volume to the second recording medium, when copying to the first recording medium is not possible.

2. The storage system according to claim 1,
wherein, when copying to the first recording medium is not possible, the control apparatus selects, as the second recording medium, a portable recording medium included in unused portable recording media of the plurality of portable recording media and having an identification number that is different from all of the plurality of logical volumes.

3. The storage system according to claim 2,
wherein copying to the first recording medium is not possible and a portable recording medium having an identification number that is different from all of the plurality of logical volumes is not included in the unused portable recording media of the plurality of portable recording media, the control apparatus selects, from logical volumes having the same identification numbers as identification numbers of the unused portable recording media, a logical volume having a predicted time until a next request for the copying is issued is the longest and selects, as the second recording medium, a portable recording medium having the same identification number as the identification number of the selected logical volume.

4. The storage system according to claim 3,
wherein the control apparatus estimates a logical volume whose predicted time until a next request for the copying is issued is the longest, based on a value of a generation corresponding to each of the plurality of logical volumes and a value of the generation when a last request for the copying of each of the plurality of logical volumes was received, the value of the generation being incremented when the corresponding one of the plurality of logical volumes is backed up from the first storage to the second storage.

5. The storage system according to claim 2,
wherein, when copying to the first recording medium is not possible and a portable recording medium having an identification number different from all of the plurality of logical volumes is not included in the unused portable recording media of the plurality of portable recording media, the control apparatus selects one of the logical volumes having the same identification numbers as the identification numbers of the unused portable recording media, based on history information of processing of backup from the first storage to the second storage with respect to each of the plurality of logical volumes, and selects, as the second recording medium, the portable recording medium having the same identification number as the identification number of the selected logical volume.

6. The storage system according to claim 5,
wherein, when copying to the first recording medium is not possible and a portable recording medium having an identification number different from all of the plurality of logical volumes is not included in the unused portable recording media of the plurality of portable recording media, the control apparatus selects, from the logical volumes having the same identification numbers as the identification numbers of the unused portable recording media, a logical volume whose predicted time until processing for backup from the first storage to the second storage is executed next time is larger than or equal to a predetermined time, based on the history information, and selects, as the second recording medium, a portable recording medium having the same identification number as the identification number of the selected logical volume.

7. The storage system according to claim 5,
wherein, when copying to the first recording medium is not possible and a portable recording medium having an identification number different from all of the plurality of logical volumes is not included in the unused portable recording media of the plurality of portable recording media, the control apparatus selects, from the logical volumes having the same identification numbers as the identification numbers of the unused portable recording media, a logical volume whose predicted time until processing for backup from the first storage to the second storage is executed is the longest, based on the history information, and selects, as the second recording medium, a portable recording medium having the same identification number as the identification number of the selected logical volume.

8. The storage system according to claim 2,
wherein, when copying to the first recording medium is not possible and a portable recording medium having an identification number different from all of the plurality of logical volumes is not included in the unused portable recording media of the plurality of portable recording media, the control apparatus copies the first logical volume to the second recording medium selected from the plurality of portable recording media, without changing the identification number of the first logical volume.

9. The storage system according to claim 1,
wherein, when copying to the first recording medium is not possible, the control apparatus determines whether or not to execute copying to the second recording medium, based on use history of portable recording media used for copy processing according to a request for the copying and the number of unused portable recording media of the plurality of portable recording media presently stored in the library apparatus.

10. The storage system according to claim 9,
wherein, based on the number of portable recording media used in each certain period of time, the number being based on the use history, the control apparatus determines whether or not the number of unused portable recording media of the plurality of portable recording media stored in the library apparatus is larger than or equal to the number of portable recording media used for the copy processing, the number being estimated in a subsequent predetermined period based on the certain period of time and present time, and determines whether or not to perform copying to the second recording medium based on a result of the determination.

11. The storage system according to claim 1,
wherein the control apparatus causes the first recording medium to which the first logical volume is copied or the second recording medium to which the second logical volume is copied to be ejected to outside of the library apparatus.

12. A control apparatus connected to a library apparatus that stores a plurality of portable recording media therein and writes and reads data by using the stored portable recording media and to a storage apparatus to control access to a plurality of logical volumes by using the storage apparatus as a first storage and using a storage area provided by the plurality of portable recording media as a second storage, the control apparatus comprising:
a receiving unit configured to receive a request for copying a first logical volume of the plurality of logical volumes; and
a control unit configured to copy the first logical volume to, of the plurality of portable recording media, an unused first recording medium having the same identification number as an identification number of the first logical volume, when copying to the first recording medium is possible, and to select an unused second recording medium from the plurality of portable recording media, generate a second logical volume in which the identification number of the first logical volume is changed to the same identification number as an identification number of the second recording medium, and copy the generated second logical volume to the second recording medium, when copying to the first recording medium is not possible.

13. A control method for a control apparatus connected to a library apparatus that stores a plurality of portable recording media therein and writes and reads data by using the stored portable recording media and to a storage apparatus to control access to a plurality of logical volumes by using the storage apparatus as a first storage and using a storage area provided by the plurality of portable recording media as a second storage, the control method comprising:
receiving a request for copying a first logical volume of the plurality of logical volumes; and
copying the first logical volume to, of the plurality of portable recording media, an unused first recording medium having the same identification number as an identification number of the first logical volume, when copying to the first recording medium is possible, and selecting an unused second recording medium from the plurality of portable recording media, generating a second logical volume in which the identification number of the first logical volume is changed to the same identification number as an identification number of the second recording medium, and copying the generated second logical volume to the second recording medium, when copying to the first recording medium is not possible.

14. The control method according to claim 13,
wherein, when copying to the first recording medium is not possible, a portable recording medium included in unused portable recording media of the plurality of portable recording media and having an identification number that is different from all of the plurality of logical volumes is selected as the second recording medium.

15. The control method according to claim 14,
wherein copying to the first recording medium is not possible and a portable recording medium having an identification number that is different from all of the plurality of logical volumes is not included in the unused portable recording media of the plurality of portable recording media, a logical volume having a predicted time until a next request for the copying is issued is the longest is selected from logical volumes having the same identification numbers as identification numbers of the unused portable recording media, and a portable recording medium having the same identification number as the identification number of the selected logical volume is selected as the second recording medium.

16. The control method according to claim 14,
wherein, when copying to the first recording medium is not possible and a portable recording medium having an identification number different from all of the plurality of logical volumes is not included in the unused portable recording media of the plurality of portable recording media, one of the logical volumes having the same identification numbers as the identification numbers of the unused portable recording media is selected based on history information of processing of backup from the first storage to the second storage with respect to each of the plurality of logical volumes, and the portable recording medium having the same identification number as the identification number of the selected logical volume is selected as the second recording medium.

17. The control method according to claim 16,
wherein, when copying to the first recording medium is not possible and a portable recording medium having an identification number different from all of the plurality of logical volumes is not included in the unused portable recording media of the plurality of portable recording media, a logical volume whose predicted time until processing for backup from the first storage to the second storage is executed next time is larger than or equal to a predetermined time is selected from the logical volumes having the same identification numbers as the identification numbers of the unused portable recording media, based on the history information, and a portable recording medium having the same identification number as the identification number of the selected logical volume is selected as the second recording medium.

18. The control method according to claim 16,
wherein, when copying to the first recording medium is not possible and a portable recording medium having an identification number different from all of the plurality of logical volumes is not included in the unused portable recording media of the plurality of portable recording media, a logical volume whose predicted time until processing for backup from the first storage to the second storage is executed is the longest is selected from the logical volumes having the same identification numbers as the identification numbers of the unused portable recording media, and based on the history information, a portable recording medium having the same identification number as the identification number of the selected logical volume is selected as the second recording medium.

19. The control method according to claim 14,
wherein, when copying to the first recording medium is not possible and a portable recording medium having an identification number different from all of the plurality of logical volumes is not included in the unused portable recording media of the plurality of portable recording media, the first logical volume is copied to the second recording medium selected from the plurality of portable recording media, without changing the identification number of the first logical volume.

20. The control method according to claim 13,
wherein, when copying to the first recording medium is not possible, whether or not to execute copying to the second recording medium is determined based on use history of portable recording media used for copy processing according to a request for the copying and the number of unused portable recording media of the plurality of portable recording media presently stored in the library apparatus.
